(19) United States
(12) Patent Application Publication
(10) Pub. No.: US 2022/0267569 A1
(43) Pub. Date: Aug. 25, 2022

(54) MIXED COMPOSITION, FILM AND VEHICLE GLASS

(71) Applicant: SUMITOMO CHEMICAL COMPANY, LIMITED, Tokyo (JP)

(72) Inventors: Yasuharu SHIMAZAKI, Osaka-shi (JP); Michiru UEHARA, Osaka-shi (JP); Tomonori MIYAMOTO, Osaka-shi (JP)

(73) Assignee: SUMITOMO CHEMICAL COMPANY, LIMITED, Tokyo (JP)

(21) Appl. No.: 17/604,851

(22) PCT Filed: Jun. 11, 2020
(86) PCT No.: PCT/JP2020/022949

§ 371 Date: Oct. 19, 2021

(30) Foreign Application Priority Data
Jun. 19, 2019 (JP) 2019-114128

(51) Int. Cl. C08K 5/5419; C08L 83/04; C09K 3/18; C09D 183/04; C09D 7/63; C03C 17/30; C03C 17/32

(52) U.S. Cl. CPC C08K 5/5419; C08L 83/04; C09K 3/18; C09D 183/04; C08L 2205/025; C03C 17/30; C03C 17/32; C08K 2201/014; C08L 2203/162; C09D 7/63

(57) ABSTRACT

The present invention includes a mixed composition of an organosilicon compound (A) represented by formula (a1), an organosilicon compound (B) represented by formula (b1) and a curing inhibitor (C), and a mixed composition of the organosilicon compound (A) represented by formula (a1), the organosilicon compound (B) represented by formula (b1), the curing inhibitor (C) and water (D).

R^{a1}—Si(X^{a1})₃ (a1)

Si(R^{b1})_{b20}(X^{b1})_{4-b20} (b1)

### TECHNICAL FIELD

The present invention relates to a mixed composition capable of forming a film having a liquid-repellent property on various base materials, a film obtained by curing the composition, and vehicle glass provided with the film.

### BACKGROUND ART

Various vehicles, houses, building equipment and the like may have a problem such as deterioration of visibility and a poor appearance due to contamination of a surface of a windowpane. Thus, a surface of a base material such as glass is required to have a good liquid-repellent property. In particular, not only prevention of deposition of liquid droplets on a surface of a base material but also easy removal of deposited liquid droplets is required.

Herein, a high slip drop speed of deposited liquid droplets is considered to be equivalent to a high slip drop property, and a high slip drop property is taken as an indication of easy removal of deposited liquid droplets.

For example, Patent Literature 1 discloses a composition obtained by mixing predetermined amounts of two silane compounds, and indicates that by using the composition, a film allowing liquid droplets to be easily removed and having a good appearance can be obtained by a simple coating method.

### CITATION LIST

### Patent Literature

Patent Literature 1: Japanese Patent Laid-Open No. 2019-11463

### SUMMARY OF INVENTION

### Technical Problem

A water-repellent film as disclosed in Patent Literature 1 may be exposed to an outdoor environment, and in such a case, good outdoor durability is required.

An object of the present invention is to provide a mixed composition that forms a film which has a good liquid-repellent property (water-repellent property in particular) and slip drop property, and can maintain an excellent liquid-repellent property (water-repellent property in particular) even when used outdoors for a long period of time.

### Solution to Problem

The present invention is as follows.

[1] A mixed composition of an organosilicon compound (A) represented by formula (a1), an organosilicon compound (B) represented by formula (b1) and a curing inhibitor (C):

[Formula 1]

R^{a1}—Si(X^{a1})₃ (a1)

wherein R^{a1} represents a hydrocarbon group having 6 or more carbon atoms, and —CH₂— in the hydrocarbon group is optionally replaced by —O—; and

X^{a1} represents a hydrolyzable group, and

[Formula 2]

Si(R^{b1})_{b20}(X^{b1})_{4-b20} (b1)

wherein R^{b1} represents a hydrocarbon group having 1 to 5 carbon atoms;

X^{b1} represents a hydrolyzable group; and

b20 is 0 or 1.

[2] A mixed composition of an organosilicon compound (A) represented by formula (a1), an organosilicon compound (B) represented by formula (b1), a curing inhibitor (C) and water (D):

[Formula 3]

R^{a1}—Si(X^{a1})₃ (a1)

wherein R^{a1} represents a hydrocarbon group having 6 or more carbon atoms, and —CH₂— in the hydrocarbon group is optionally replaced by —O—; and

X^{a1} represents a hydrolyzable group, and

[Formula 4]

Si(R^{b1})_{b20}(X^{b1})_{4-b20} (b1)

wherein R^{b1} represents a hydrocarbon group having 1 to 5 carbon atoms;

X^{b1} represents a hydrolyzable group; and b20 is 0 or 1.

[3] The composition according to [2], wherein the amount of water (D) is 0.1 to 90 mass %.
[4] The composition according to any one of [1] to [3], wherein the molar ratio (B/A) of the organosilicon compound (B) to the organosilicon compound (A) is 0.01 to 48.
[5] The composition according to any one of [1] to [4], wherein the total amount of the organosilicon compound (A) and the organosilicon compound (B) is 0.01 to 30 mass %.
[6] The composition according to any one of [1] to [5], wherein the mass ratio (C/(A+B)) of the curing inhibitor (C) to the total amount of the organosilicon compound (A) and the organosilicon compound (B) is 0.9 or less.
[7] The composition according to any one of [1] to [6], wherein R^{a1} in formula (a1) is a saturated hydrocarbon group.
[8] The composition according to any one of [1] to [7], wherein the curing inhibitor (C) comprises a compound (C1) having at least one selected from a hydroxy group and a hydrolyzable group at an end and containing a siloxane bond in a structure.
[9] The composition according to [8], wherein the compound (C1) is a compound represented by formula (c1):

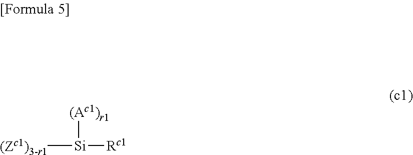

wherein A^{c1} represents a hydroxy group or a hydrolyzable group, and a plurality of A^{c1}s, when present, are optionally different from each other;

Z^{c1} represents a hydrocarbon group, a trialkylsilyl group-containing molecular chain or a siloxane backbone-containing group, and a plurality of Z^{c1}s, when present, are optionally different from each other;

r1 represents an integer of 1 to 3; and

R^{c1} represents a group represented by formula (c11):

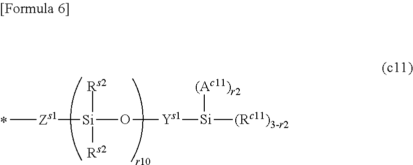

wherein R^{s2}s each independently represent an alkyl group having 1 to 4 carbon atoms;

R^{c11} represents a hydrocarbon group or a trialkylsilyloxy group, hydrogen atoms in the hydrocarbon group or the trialkylsilyloxy group are optionally replaced by fluorine atoms, and a plurality of R^{c11}s, when present, are optionally different from each other;

A^{c11} represents a hydroxy group or a hydrolyzable group, and a plurality of A^{c11}s, when present, are optionally different from each other;

Z^{s1} represents —O— or a divalent hydrocarbon group, and —CH₂— in the divalent hydrocarbon group is optionally replaced by —O—;

Y^{s1} represents a singly bond or —Si(R^{s2})₂-L^{s1}-, L^{s1} represents a divalent hydrocarbon group, and —CH₂— in the divalent hydrocarbon group is optionally replaced by —O—;

r2 represents an integer of 0 to 3;

r10 represents an integer of 1 or more; and

* represents a bond.

[10] The composition according to [9], wherein the compound represented by formula (c1) is a compound represented by formula (c1-1):

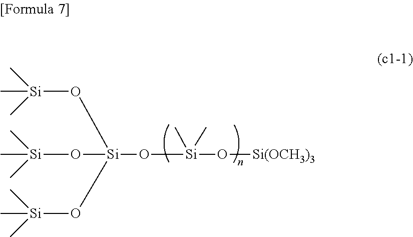

wherein n is an integer of 1 to 30.

[11] The composition according to any one of [1] to [7], wherein the curing inhibitor (C) comprises a compound represented by formula (c2):

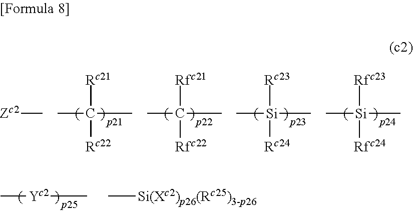

wherein R^{c21}, R^{c22}, R^{c23} and R^{c24} are each independently a hydrogen atom or an alkyl group having 1 to 4 carbon atoms, a plurality of R^{c21}s, when present, are optionally different from each other, a plurality of R^{c22}s, when present, are optionally different from each other, a plurality of R^{c23}s, when present, are optionally different from each other, and a plurality of R^{c24}s, when present, are optionally different from each other;

Rf^{c21}, Rf^{c22}, Rf^{c23} and Rf^{c24} are each independently an alkyl group having 1 to 20 carbon atoms with one or more hydrogen atoms replaced by fluorine atoms, or a fluorine atom, a plurality of Rf^{c21}s, when present, are optionally different from each other, a plurality of Rf^{c22}s, when present, are optionally different from each other, a plurality of Rf^{c23}s, when present, are optionally different from each other, and a plurality of Rf^{c24}s, when present, are optionally different from each other;

R^{c25} is an alkyl group having 1 to 20 carbon atoms, and a plurality of R^{c25}s, when present, are optionally different from each other;

X^{c2} is a hydrolyzable group, and a plurality of X^{c2}s, when present, are optionally different from each other;

Y^{c2} is —O—, —NH— or —S—, and a plurality of Y^{c2}s, when present, are optionally different from each other;

Z^{c2} is a vinyl group, an α-methylvinyl group, a styryl group, a methacryloyl group, an acryloyl group, an amino group, an isocyanate group, an isocyanurate group, an epoxy group, an ureido group or a mercapto group;

p21 is an integer of 1 to 20, p22, p23 and p24 are each independently an integer of 0 to 10, and p25 is an integer of 0 to 10;

p26 is an integer of 1 to 3; and

Z^{c2}—, —Si(X^{c2})ₚ₂₆(R^{c25})₃₋ₚ₂₆, p21-{C(R^{c21})(R^{c22})}-s, p22-{C(Rf^{c21})(Rf^{c22})}-s, p23-{Si(R^{c23})(R^{c24})}-s, p24-{Si(Rf^{c23})(Rf^{c24})}-s and p25-Y^{c2}-s are bonded in line in any order as long as Z^{c2}— and —Si(X^{c2})ₚ₂₆ (R^{c25})₃₋ₚ₂₆ are at the ends and —Y^{c2}-s are not connected to each other.

[12] The composition according to [11], wherein the compound represented by formula (c2) is a compound represented by formula (c2-1):

[Formula 9]

Z^{c21}—C_{q}H_{2q}—Y^{c21}—CᵣH₂ᵣ—Si(X^{c21})ₚ₂₇(R^{c26})₃₋ₚ₂₇ (c21)

wherein X^{c21} is a methoxy group or an ethoxy group, and X^{c21}s, when present, are optionally different from each other;

Y^{c21} is —NH—, —CH₂— or —O—;

Z^{c21} is an amino group or a mercapto group;

R^{c26} is an alkyl group having 1 to 20 carbon atoms, and R^{c26}s, when present, are optionally different from each other;

p27 is an integer of 1 to 3;

q is an integer of 2 to 5; and

r is an integer of 0 to 10.

[13] The composition according to any one of [1] to [7], wherein the curing inhibitor (C) comprises a compound represented by formula (c3):

[Formula 10]

(X^{c3})₃Si—R^{c3}—Si(X^{c3})₃ (c3)

wherein a plurality of X^{c3}s each independently represent a hydrolyzable group; and

R^{c3} represents an alkylene group having 1 to 24 carbon atoms, —CH₂— in the alkylene group is optionally replaced by —O—, —NH— or —S—, and hydrogen atoms in the alkylene group are optionally replaced by fluorine atoms.

[14] The composition according to [13], wherein the compound represented by formula (c3) is a compound represented by formula (c3-1):

[Formula 11]

(X^{c31})₃Si—(CH₂)ₙ₃₀—Si(X^{c31})₃ (c3-1)

wherein a plurality of X^{c31}s each independently represent a methoxy group or an ethoxy group; and

n30 is an integer of 1 to 6.

[15] A film obtained by curing the composition according to any one of [1] to [14].
[16] Vehicle glass at least one surface of which is provided with the film according to [15].

The mixed compositions include those in which reaction has proceeded during a period after mixing, for example during storage.

### Advantageous Effect of Invention

The mixed composition of the present invention is capable of providing a film which has a good liquid-repellent property (water-repellent property in particular) and slip drop property and can maintain an excellent liquid-repellent property (water-repellent property in particular) even when used outdoors for a long period of time.

### DESCRIPTION OF EMBODIMENT

The present invention includes a mixed composition of an organosilicon compound (A), an organosilicon compound (B) and a curing inhibitor (C) (hereinafter, sometimes referred to as a “first mixed composition”) and a mixed composition of the organosilicon compound (A), the organosilicon compound (B), the curing inhibitor (C) and water (D) (hereinafter, sometimes referred to as a “second mixed composition”). Hereinafter, the organosilicon compound (A), the organosilicon compound (B), the curing inhibitor (C) and the water (D) will be described in this order.

1. Organosilicon compound (A)

The organosilicon compound (A) is represented by the following formula (a1).

[Formula 12]

R^{a1}—Si(X^{a1})₃ (a1)

In the above formula (a1), R^{a1} represents a hydrocarbon group having 6 or more carbon atoms, —CH₂— in the hydrocarbon group is optionally replaced by —O—, and X^{a1} represents a hydrolyzable group.

R^{a1} is preferably a saturated hydrocarbon group, more preferably a linear or branched alkyl group, still more preferably a linear alkyl group. The number of carbon atoms in the hydrocarbon group represented by R^{a1} is preferably 7 or more, more preferably 8 or more, and preferably 30 or less, more preferably 20 or less, still more preferably 15 or less. When —CH₂— in the hydrocarbon group represented by R^{a1} is replaced by —O—, the number of the replacing —O-s is counted as the number of carbon atoms.

Examples of the group in which —CH₂— in the hydrocarbon group represented by R^{a1} is replaced by —O— include groups containing one or more alkyleneoxy units. Examples of the alkyleneoxy unit include an ethyleneoxy unit and a propyleneoxy unit, and an ethyleneoxy unit is preferable.

The group in which —CH₂— in the hydrocarbon group represented by R^{a1} can be expressed as, for example, —R^{a3}—(R^{a4}—O)ₐ₁₀—R^{a5}, where R^{a3} represents a single bond or a divalent hydrocarbon group having 1 to 4 carbon atoms, R^{a4} represents a divalent hydrocarbon group having 2 to 3 carbon atoms, R^{a5} represents a hydrogen atom or a monovalent hydrocarbon group having 1 to 4 carbon atoms, and a10 represents an integer of 1 to 10. It is to be noted that the total number of carbon and oxygen atoms in the —R^{a3}—(R^{a4}—O)ₐ₁₀—R^{a5} is 6 or more. R^{a3} is preferably a divalent hydrocarbon group, examples of the divalent hydrocarbon group represented by R^{a3} include divalent saturated hydrocarbon groups such as a methylene group, an ethylene group, a propylene group and a butylene group, examples of R^{a4} include divalent saturated hydrocarbon groups such as an ethylene group and a propylene group, R^{a5} is preferably a monovalent hydrocarbon group having 1 to 4 carbon atoms, and examples of the monovalent hydrocarbon group represented by R^{a5} include monovalent saturated hydrocarbon groups such as a methyl group, an ethyl group, a propyl group and a butyl group.

The hydrocarbon group represented by R^{a1} is a linear alkyl group having 6 or more and 30 or less carbon atoms, and in particular, a hexyl group, a heptyl group, an octyl group, a nonyl group, a decyl group, an undecyl group, a dodecyl group, a tetradecyl group, a hexadecyl group and an octadecyl group are preferable, with an octyl group, a decyl group, a dodecyl group, a tetradecyl group, a hexadecyl group and an octadecyl group being particularly preferable.

Examples of the hydrolyzable group represented by X^{a1} in the above formula (a1) include groups which give a hydroxy group (silanol group) when hydrolyzed, and alkoxy groups having 1 to 6 carbon atoms, a cyano group, an acetoxy group, a chlorine atom, an isocyanate group and the like are preferable. Three X^{a1}s may be the same or different, and are preferably the same. X^{a1} is preferably an alkoxy group or a cyano group having 1 to 6 (more preferably 1 to 4) carbon atoms, more preferably an alkoxy group having 1 to 6 (more preferably 1 to 4) carbon atoms, and it is still more preferable that all X^{a1}s be alkoxy groups having 1 to 6 (more preferably 1 to 4) carbon atoms.

The organosilicon compound (A) is preferably one in which R^{a1} is a linear alkyl group, and all X^{s1}s are the same, and are alkoxy groups having 1 to 6 (more preferably 1 to 4, still more preferably 1 or 2) carbon atoms.

Specific examples of the organosilicon compound (A) include hexyltrimethoxysilane, hexyltriethoxysilane, heptyltrimethoxysilane, heptyltriethoxysilane, octyltrimethoxysilane, octyltriethoxysilane, nonyltrimethoxysilane, nonyltriethoxysilane, decyltrimethoxysilane, decyltriethoxysilane, undecyltrimethoxysilane, undecyltriethoxysilane, dodecyltrimethoxysilane, dodecyltriethoxysilane, tridecyltrimethoxysilane, tridecyltriethoxysilane, tetradecyltrimethoxysilane, tetradecyltriethoxysilane, pentadecyltrimethoxysilane, pentadecyltriethoxysilane, hexadecyltrimethoxysilane, hexadecyltriethoxysilane, heptadecyltrimethoxysilane, heptadecyltriethoxysilane, octadecyltrimethoxysilane and octadecyltriethoxysilane, and hexyltrimethoxysilane, hexyltriethoxysilane, octyltrimethoxysilane, octyltriethoxysilane, decyltrimethoxysilane, decyltriethoxysilane, dodecyltrimethoxysilane, dodecyltriethoxysilane, tetradecyltrimethoxysilane, tetradecyltriethoxysilane, hexadecyltrimethoxysilane, hexadecyltriethoxysilane, octadecyltrimethoxysilane and octadecyltriethoxysilane are preferable.

The organosilicon compounds (A) may be used alone, or used in combination of two or more thereof.

### 2. Organosilicon Compound (B)

The organosilicon compound (B) is represented by the following formula (b1).

[Formula 13]

Si(R^{b1})_{b20}(X^{b1})_{4-b20} (b1)

In formula (b1), R^{b1} represents a hydrocarbon group having 1 to 5 carbon atoms, X^{b1} represents a hydrolyzable group, and b20 is 0 or 1.

R^{b1} is preferably a saturated hydrocarbon group, more preferably a linear or branched alkyl group, still more preferably a linear alkyl group, particularly preferably a methyl group, an ethyl group or a propyl group.

Examples of the hydrolyzable group represented by X^{b1} in the above formula (b1) include groups similar to the hydrolyzable group represented by X^{a1}, and alkoxy groups having 1 to 6 carbon atoms, a cyano group, an acetoxy group, a chlorine atom, an isocyanate group and the like are preferable. A plurality of X^{b1}s may be the same or different, and are preferably the same. X^{b1} is preferably an alkoxy group having 1 to 6 (more preferably 1 to 4) carbon atoms, or an isocyanate group, more preferably an alkoxy group having 1 to 6 (more preferably 1 to 4) carbon atoms, and it is still more preferable that all X^{b1}s be alkoxy groups having 1 to 6 (more preferably 1 to 4) carbon atoms.

In the above formula (b1), b20 is preferably 0.

The organosilicon compound (B) is preferably one in which b20 is 0, and X^{b1} is an alkoxy group having 1 to 6 (more preferably 1 to 3) carbon atoms.

Examples of the organosilicon compound (B) include tetramethoxysilane, tetraethoxysilane, tetrapropoxysilane, tetrabutoxysilane, methyltrimethoxysilane, methyltrimethoxysilane, methyltripropoxysilane and methyltributoxysilane, and tetramethoxysilane and tetraethoxysilane are preferable.

The organosilicon compounds (B) may be used alone, or used in combination of two or more thereof.

The molar ratio (B/A) of the organosilicon compound (B) to the organosilicon compound (A) is preferably 0.01 or more and 48 or less from the viewpoint of improving the water-repellent property and the slip drop property. The molar ratio is more preferably 0.1 or more, still more preferably 0.3 or more, furthermore preferably 0.5 or more, particularly preferably 0.8 or more. The molar ratio is more preferably 40 or less, still more preferably 25 or less, furthermore preferably 12 or less, particularly preferably 10 or less, most preferably 8 or less. It is also preferable that the molar ratio be 0.1 or more and 12 or less. The molar ratio of the organosilicon compound (B) to the organosilicon compound (A) can be adjusted during preparation of the composition. The molar ratio of the organosilicon compound (B) to the organosilicon compound (A) may be calculated from the result of analysis of the composition. Where the range of the molar ratios, the amounts or the mass ratios of the components is described herein, the range can be adjusted during preparation of the composition like the above.

Where the total amount of the composition is 100 mass %, the total amount of the organosilicon compound (A) and the organosilicon compound (B) is preferably 0.01 mass % or more, more preferably 0.03 mass % or more, still more preferably 0.05 mass % or more, and preferably 30 mass % or less, more preferably 15 mass % or less, still more preferably 5 mass % or less, particularly preferably 2 mass % or less.

### 3. Curing Inhibitor (C)

The curing inhibitor (C) is a compound which suppresses curing of the film, and examples thereof include compounds which suppress condensation reaction between hydrolysable groups remaining in the organosilicon compound (A) and the organosilicon compound (B) after film formation. When film formation is performed using a composition in which the organosilicon compound (A) and the organosilicon compound (B) are mixed, the obtained film may continue to cure after film formation operations. In the present invention, the use of the curing inhibitor (C) may ensure that even when the obtained film is exposed outdoors, excessive curing does not occur, and a decrease in contact angle is suppressed.

The mass ratio (C/(A+B)) of the curing inhibitor (C) to the total amount of the organosilicon compound (A) and the organosilicon compound (B) is, for example, 1.0 or less, preferably 0.9 or less, more preferably 0.7 or less, still more preferably 0.6 or less, furthermore preferably 0.4 or less, particularly preferably 0.3 or less, and preferably 0.0001 or more, more preferably 0.0005 or more, still more preferably 0.001 or more.

The molar ratio (C/(A+B)) of the curing inhibitor (C) to the total amount of the organosilicon compound (A) and the organosilicon compound (B) is preferably 0.00001 or more, more preferably 0.00005 or more, still more preferably 0.0001 or more, and preferably 1 or less, more preferably 0.8 or less, still more preferably 0.7 or less, furthermore preferably 0.5 or less.

Where the total amount of the composition is 100 mass %, the amount of the curing inhibitor (C) is preferably 5 mass % or less, more preferably 3 masse or less, still more preferably 1 mass % or less, particularly preferably 0.5 mass % or less, and preferably 0.00001 mass % or more, more preferably 0.00005 mass % or more, still more preferably 0.0001 mass % or more.

Where the total amount of the composition is 100 mass %, the total amount of the organosilicon compound (A), the organosilicon compound (B) and the curing inhibitor (C) is preferably 0.01 mass %, or more, more preferably 0.03 mass % or more, still more preferably 0.05 mass % or more, and preferably 30 mass % or less, more preferably 15 mass % or less, still more preferably 5 mass % or less, particularly preferably 2 mass % or less.

The curing inhibitors (C) may be used alone, or used in combination of two or more thereof.

Preferably, the curing inhibitor (C) comprises at least one compound selected from the compounds (C1) to (C3) described below. At least one compound selected from the compounds (C1) to (C3) is present at preferably 50 mass % or more, more preferably 70 mass % or more, still more preferably 90 mass % or more, particularly preferably 100 mass %, per 100 mass % of the curing inhibitor (C).

### 3-1. Compound (C1)

Preferably, the curing inhibitor (C) comprises a compound (C1) having at least one selected from a hydroxy group and a hydrolyzable group at an end and containing a siloxane bond in a structure.

The compound (C1) is preferably a compound of the following formula (c1).

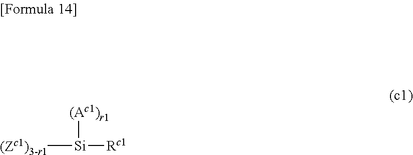

In formula (c1),

A^{c1} represents a hydroxy group or a hydrolyzable group, and a plurality of A^{c1}s, when present, are optionally different from each other;

Z^{c1} represents a hydrocarbon group, a trialkylsilyl group-containing molecular chain or a siloxane backbone-containing group, and a plurality of Z^{c1}s, when present, are optionally different from each other;

r1 represents an integer of 1 to 3; and

R^{c1} represents a group represented by formula (c11).

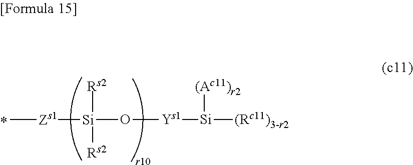

In formula (c11),

R^{a2}s each independently represent an alkyl group having 1 to 4 carbon atoms;

R^{c11} represents a hydrocarbon group or a trialkylsilyloxy group, hydrogen atoms in the hydrocarbon group or the trialkylsilyloxy group are optionally replaced by fluorine atoms, and a plurality of R^{c11}s, when present, are optionally different from each other;

A^{c11} represents a hydroxy group or a hydrolyzable group, and a plurality of A^{c11}s, when present, are optionally different from each other;

Z^{s1} represents —O— or a divalent hydrocarbon group, and —CH₂— in the divalent hydrocarbon group is optionally replaced by —O—;

Y^{s1} represents a singly bond or —Si(R^{s2})₂-L^{s1}-, L^{s1} represents a divalent hydrocarbon group, and —CH₂— in the divalent hydrocarbon group is optionally replaced by —O—;

r2 represents an integer of 0 to 3;

r10 represents an integer of 1 or more; and

* represents a bond.

R^{c1} represents a group of the above formula (c11). First, the moiety represented by formula (s2) (hereinafter, sometimes referred to as a molecular chain (s2)) in the group represented by formula (c11) will be described.

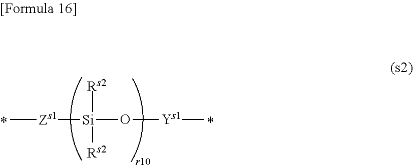

The number of carbon atoms in the alkyl group represented by R^{s2} is preferably 1 to 4, more preferably 1 to 3, still more preferably 1 to 2. Examples of the alkyl group represented by R^{s2} is preferably a methyl group, an ethyl group, a propyl group and a butyl group, and a methyl group or an ethyl group is preferable, with a methyl group being particularly preferable.

r10 is preferably 1 to 100, more preferably 1 to 80, still more preferably 1 to 50, particularly preferably 1 to 30.

The number of carbon atoms in the divalent hydrocarbon group represented by Z^{s1} or L^{s1} is preferably 1 to 10, more preferably 1 to 6, still more preferably 1 to 4. The divalent hydrocarbon group is preferably chainlike, and may be linear or branched when the divalent hydrocarbon group is chainlike. The divalent hydrocarbon group is preferably a divalent aliphatic hydrocarbon group, which is preferably an alkanediyl group. Examples of the divalent hydrocarbon group include a methylene group, an ethylene group, a propylene group and a butylene group.

Further, some of —CH₂-s in the divalent hydrocarbon group are optionally replaced by —O—. In this case, both two consecutive —CH₂-s are not replaced by —O—, and —CH₂-adjacent to the Si atom is not replaced by —O—. When two or more —CH₂-s are replaced by —O—, the number of carbon atoms between —O— and —O— is preferably 2 to 4, more preferably 2 or 3. As the group in which a part of the divalent hydrocarbon group is replaced by —O—, specifically, groups having a (poly)ethylene glycol unit, groups having a (poly)propylene glycol unit, and the like can be exemplified.

In the molecular chain (s2), Z^{s1} is preferably —O— or a divalent aliphatic hydrocarbon group, more preferably —O—.

In the molecular chain (s2), Y^{s1} is preferably a single bond.

Preferably, Z^{s1} is —O— and Y^{s1} is a single bond in the molecular chain (s2), i.e. the molecular chain consists only of repeated dialkylsilyloxy groups.

Examples of the molecular chain (s2) include molecular chains represented by the following formulae. In the formulae, r21 represents an integer of 1 to 30, and * represents a bond to a silicon atom.

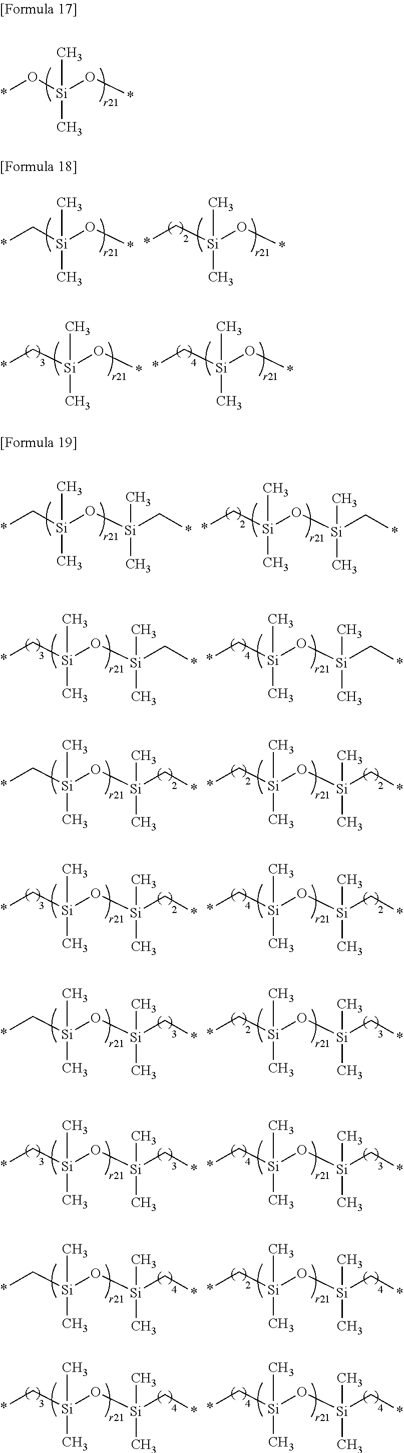

In formula (c11), R^{c11} represents a hydrocarbon group or a trialkylsilyloxy group, and hydrogen atoms in the hydrocarbon group or the trialkylsilyloxy group are optionally replaced by fluorine atoms. The number of the replacing fluorine atoms is preferably 1 or more, more preferably 3 or more, and preferably equal to or less than 2×A+1 where A is the number of carbon atoms.

When R^{c1} is a hydrocarbon group, the number of carbon atoms in the group is preferably 1 to 4, more preferably 1 to 3, still more preferably 1 or 2. When R^{c1} is a hydrocarbon group, an aliphatic hydrocarbon group is preferable, and an alkyl group is more preferable. Examples of the alkyl group include a methyl group, an ethyl group, a propyl group and a butyl group.

When R^{c11} is a trialkylsilyloxy group, the number of carbon atoms in the alkyl group forming the trialkylsilyloxy group is preferably 1 to 4, more preferably 1 to 3, still more preferably 1 or 2. Examples of the alkyl group include a methyl group, an ethyl group, a propyl group and a butyl group. The three alkyl groups forming the trialkylsilyloxy group may be the same or different, and are preferably the same. The trialkylsilyloxy group means a group in which an oxygen atom is bonded to a silicon atom of a trialkylsilyl group.

In formula (c11), A^{c11} represents a hydroxy group or a hydrolyzable group. The hydrolyzable group may be a group which gives a hydroxy group (silanol group) when hydrolyzed, and preferred examples thereof include alkoxy groups having 1 to 4 carbon atoms, such as a methoxy group, an ethoxy group, a propoxy group and a butoxy group; an acetoxy group; a chlorine atom; and an isocyanate group. A^{c11} is preferably an alkoxy group having 1 to 4 carbon atoms, or a hydroxy group, more preferably an alkoxy group having 1 or 2 carbon atoms, or a hydroxy group.

R^{c1} is preferably a group represented by formula (c11-1) or formula (c11-2).

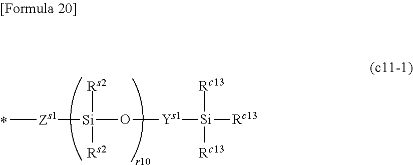

In formula (c1-1), Z^{s1}, R^{s2}, Y^{s1} and r10 have the same meanings as described above;

R^{c13}s each independently represent a hydrocarbon group or a trialkylsilyloxy group, and hydrogen atoms in the hydrocarbon group or the trialkylsilyloxy group are optionally replaced by fluorine atoms; and

* represents a bond to a silicon atom.

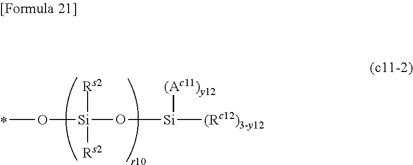

In formula (c11-2), R^{s2} and r10 have the same meanings as those described above;

A^{c12} represents a hydroxy group or a hydrolyzable group, and a plurality of A^{c12}s, when present, are optionally different from each other;

R^{c12} represents a hydrocarbon group, and a plurality of R^{c12}s, when present, are optionally different from each other;

y12 represents an integer of 1 to 3; and

* represents a bond to a silicon atom.

First, the group represented by formula (c11-1) will be described.

Examples of the hydrocarbon group represented by R^{c3} in formula (c11-1) include those similar to the hydrocarbon groups described for R^{c11} above, and the hydrocarbon group is preferably an alkyl group having 1 to 4 carbon atoms, more preferably an alkyl group having 1 to 3 carbon atoms, still more preferably an alkyl group having 1 or 2 carbon atoms. In particular, when all R^{c13}s are hydrocarbon groups, R^{c3} is preferably an alkyl group. The three R^{c13}s may be the same or different, and are preferably the same. When all R^{c13}s are hydrocarbon groups, the total number of carbon atoms of the three R^{c13}s is preferably 9 or less, more preferably 6 or less, still more preferably 4 or less. Preferably at least one, more preferably at least two, particularly preferably all of the three R^{c13}s are methyl groups.

Examples of the trialkylsilyloxy group represented by R^{c13} in formula (c11-1) include those similar to the trialkylsilyloxy groups described for R^{c11} above, and the same applies to the preferred range. In the above formula (c11-1), at least one of the R^{c13}s may be a trialkylsilyloxy group, and it is also preferable that all of the R^{c13}s be trialkylsilyloxy groups.

The group represented by formula (c11-1) is more preferably a group of the following formula (s3-1), still more preferably a group of the following formula (s3-1-1)

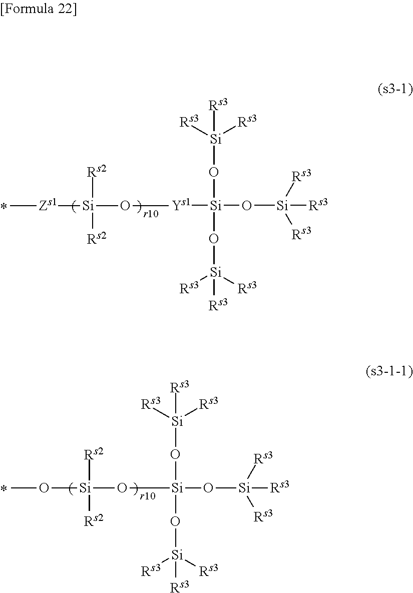

In formulae (s3-1) and (s3-1-1), R^{s2}, Y^{s1}, Z^{s1} and r10 have the same meanings as those described above. R^{s3} represents an alkyl group having 1 to 4 carbon atoms. * represents a bond to a silicon atom.

It is also preferable that the group represented by formula (c11-1) be a group of the following formula (s3-2), more preferably a group of the following formula (s3-2-1).

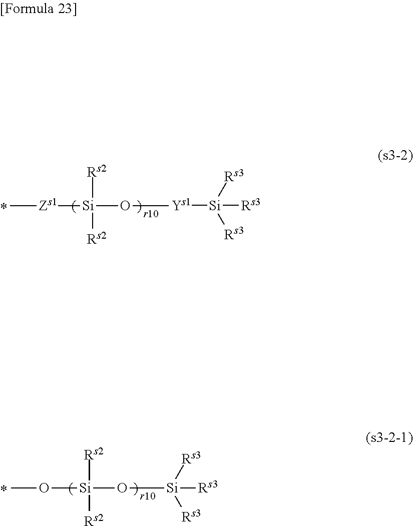

In formulae (s3-2) and (s3-2-1), R^{s2}, R^{s3}, Y^{s1}, Z^{s1} and r10 have the same meanings as those described above. * represents a bond to a silicon atom.

The number of carbon atoms in the alkyl group represented by R^{SS} is preferably 1 to 3, more preferably 1 or 2. In formulae (s3-1), (s3-1-1), (s3-2) and (s3-2-1), the total number of carbon atoms in R^{s3}s in —Si(R^{s3})₃ is preferably 9 or less, more preferably 6 or less, still more preferably 4 or less. Further, preferably at least one, more preferably at least two, particularly preferably all of the three R^{s3}s in —Si(R^{s3})₃ are methyl groups.

The group represented by formula (c11-1) is preferably a group represented by formula (s3-1-1) or formula (s3-2-1).

Examples of the group represented by formula (c11-1) include groups represented by formula (s3-1).

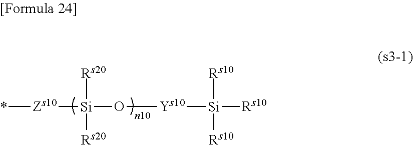

TABLE 1

| | Z^{s10} | R^{s20} | n10 | Y^{s10} | R^{s10} |
|---|---|---|---|---|---|
| (s3-I-1) | *—O—* | CH₃—* | 1~30 | — | (CH₃)₃SiO—* |
| (s3-I-2) | *—O—* | CH₃—* | 1~30 | *—Si(CH₃)₂—CH₂—* | (CH₃)₃SiO—* |
| (s3-I-3) | *—O—* | CH₃—* | 1~30 | *—Si(CH₃)₂—(CH₂)₂—* | (CH₃)₃SiO—* |
| (s3-I-4) | *—O—* | CH₃—* | 1~30 | *—Si(CH₃)₂—(CH₂)₃—* | (CH₃)₃SiO—* |
| (s3-I-5) | *—O—* | CH₃—* | 1~30 | *—Si(CH₃)₂—(CH₂)₄—* | (CH₃)₃SiO—* |
| (s3-I-6) | *—CH₂—* | CH₃—* | 1~30 | — | (CH₃)₃SiO—* |
| (s3-I-7) | *—CH₂—* | CH₃—* | 1~30 | *—Si(CH₃)₂—CH₂—* | (CH₃)₃SiO—* |
| (s3-I-8) | *—CH₂—* | CH₃—* | 1~30 | *—Si(CH₃)₂—(CH₂)₂—* | (CH₃)₃SiO—* |
| (s3-I-9) | *—CH₂—* | CH₃—* | 1~30 | *—Si(CH₃)₂—(CH₂)₃—* | (CH₃)₃SiO—* |
| (s3-I-10) | *—CH₂—* | CH₃—* | 1~30 | *—Si(CH₃)₂—(CH₂)₄—* | (CH₃)₃SiO—* |
| (s3-I-11) | *—(CH₂)₂—* | CH₃—* | 1~30 | — | (CH₃)₃SiO—* |
| (s3-I-12) | *—(CH₂)₂—* | CH₃—* | 1~30 | *—Si(CH₃)₂—CH₂—* | (CH₃)₃SiO—* |
| (s3-I-13) | *—(CH₂)₂—* | CH₃—* | 1~30 | *—Si(CH₃)₂—(CH₂)₂—* | (CH₃)₃SiO—* |
| (s3-I-14) | *—(CH₂)₂—* | CH₃—* | 1~30 | *—Si(CH₃)₂—(CH₂)₃—* | (CH₃)₃SiO—* |
| (s3-I-15) | *—(CH₂)₂—* | CH₃—* | 1~30 | *—Si(CH₃)₂—(CH₂)₄—* | (CH₃)₃SiO—* |
| (s3-I-16) | *—(CH₂)₃—* | CH₃—* | 1~30 | — | (CH₃)₃SiO—* |
| (s3-I-17) | *—(CH₂)₃—* | CH₃—* | 1~30 | *—Si(CH₃)₂—CH₂—* | (CH₃)₃SiO—* |
| (s3-I-18) | *—(CH₂)₃—* | CH₃—* | 1~30 | *—Si(CH₃)₂—(CH₂)₂—* | (CH₃)₃SiO—* |
| (s3-I-19) | *—(CH₂)₃—* | CH₃—* | 1~30 | *—Si(CH₃)₂—(CH₂)₃—* | (CH₃)₃SiO—* |
| (s3-I-20) | *—(CH₂)₃—* | CH₃—* | 1~30 | *—Si(CH₃)₂—(CH₂)₄—* | (CH₃)₃SiO—* |
| (s3-I-21) | *—(CH₂)₄—* | CH₃—* | 1~30 | — | (CH₃)₃SiO—* |
| (s3-I-22) | *—(CH₂)₄—* | CH₃—* | 1~30 | *—Si(CH₃)₂—CH₂—* | (CH₃)₃SiO—* |
| (s3-I-23) | *—(CH₂)₄—* | CH₃—* | 1~30 | *—Si(CH₃)₂—(CH₂)₂—* | (CH₃)₃SiO—* |
| (s3-I-24) | *—(CH₂)₄—* | CH₃—* | 1~30 | *—Si(CH₃)₂—(CH₂)₃—* | (CH₃)₃SiO—* |
| (s3-I-25) | *—(CH₂)₄—* | CH₃—* | 1~30 | *—Si(CH₃)₂—(CH₂)₄—* | (CH₃)₃SiO—* |

TABLE 2

| | Z^{s10} | R^{s20} | n10 | Y^{s10} | R^{s10} |
|---|---|---|---|---|---|
| (s3-I-26) | *—O—* | CH₃—* | 1~30 | — | CH₃—* |
| (s3-I-27) | *—O—* | CH₃—* | 1~30 | *—Si(CH₃)₂—CH₂—* | CH₃—* |
| (s3-I-28) | *—O—* | CH₃—* | 1~30 | *—Si(CH₃)₂—(CH₂)₂—* | CH₃—* |
| (s3-I-29) | *—O—* | CH₃—* | 1~30 | *—Si(CH₃)₂—(CH₂)₃—* | CH₃—* |
| (s3-1-30) | *—O—* | CH₃—* | 1~30 | *—Si(CH₃)₂—(CH₂)₄—* | CH₃—* |
| (s3-I-31) | *—CH₂—* | CH₃—* | 1~30 | — | CH₃—* |
| (s3-I-32) | *—CH₂—* | CH₃—* | 1~30 | *—Si(CH₃)₂—CH₂—* | CH₃—* |
| (s3-I-33) | *—CH₂—* | CH₃—* | 1~30 | *—Si(CH₃)₂—(CH₂)₂—* | CH₃—* |
| (s3-I-34) | *—CH₂—* | CH₃—* | 1~30 | *—Si(CH₃)₂—(CH₂)₃—* | CH₃—* |
| (s3-I-35) | *—CH₂—* | CH₃—* | 1~30 | *—Si(CH₃)₂—(CH₂)₄—* | CH₃—* |
| (s3-I-36) | *—(CH₂)₂—* | CH₃—* | 1~30 | — | CH₃—* |
| (s3-I-37) | *—(CH₂)₂—* | CH₃—* | 1~30 | *—Si(CH₃)₂—CH₂—* | CH₃—* |
| (s3-I-38) | *—(CH₂)₂—* | CH₃—* | 1~30 | *—Si(CH₃)₂—CH₂)₂—* | CH₃—* |
| (s3-I-39) | *—(CH₂)₂—* | CH₃—* | 1~30 | *—Si(CH₃)₂—(CH₂)₃—* | CH₃—* |
| (s3-I-40) | *—(CH₂)₂—* | CH₃—* | 1~30 | *—Si(CH₃)₂—(CH₂)₄—* | CH₃—* |
| (s3-I-41) | *—(CH₂)₃—* | CH₃—* | 1~30 | — | CH₃—* |
| (s3-I-42) | *—(CH₂)₃—* | CH₃—* | 1~30 | *—Si(CH₃)₂—CH₂—* | CH₃—* |
| (s3-I-43) | *—(CH₂)₃—* | CH₃—* | 1~30 | *—Si(CH₃)₂—(CH₂)₂—* | CH₃—* |
| (s3-I-44) | *—(CH₂)₃—* | CH₃—* | 1~30 | *—Si(CH₃)₂—(CH₂)₃—* | CH₃—* |
| (s3-I-45) | *—(CH₂)₃—* | CH₃—* | 1~30 | *—Si(CH₃)₂—(CH₂)₄—* | CH₃—* |
| (s3-I-46) | *—(CH₂)₄—* | CH₃—* | 1~30 | — | CH₃—* |
| (s3-I-47) | *—(CH₂)₄—* | CH₃—* | 1~30 | *—Si(CH₃)₂—CH₂—* | CH₃—* |
| (s3-I-48) | *—(CH₂)₄—* | CH₃—* | 1~30 | *—Si(CH₃)₂—(CH₂)₂—* | CH₃—* |
| (s3-I-49) | *—(CH₂)₄—* | CH₃—* | 1~30 | *—Si(CH₃)₂—(CH₂)₃—* | CH₃—* |
| (s3-I-50) | *—(CH₂)₄—* | CH₃—* | 1~30 | *—Si(CH₃)₂—(CH₂)₄—* | CH₃—* |

Next, the group represented by formula (c11-2) will be described.

In formula (c11-2), A^{c12} represents a hydroxy group or a hydrolyzable group. The hydrolyzable group may be a group which gives a hydroxy group (silanol group) when hydrolyzed, and preferred examples thereof include alkoxy groups having 1 to 4 carbon atoms, such as a methoxy group, an ethoxy group, a propoxy group and a butoxy group; an acetoxy group; a chlorine atom; and an isocyanate group. A^{c12} is an alkoxy group having 1 to 4 carbon atoms, or a hydroxy group, more preferably an alkoxy group having 1 or 2 carbon atoms, or a hydroxy group. A plurality of A^{c12}s, when present, may be the same or different, and are preferably the same.

Examples of the hydrocarbon group represented by R^{c12} include those similar to the hydrocarbon groups described for R^{c11} above, and the hydrocarbon group is preferably an alkyl group having 1 to 4 carbon atoms, more preferably a methyl group or an ethyl group, still more preferably a methyl group. A plurality of R^{c12}s, when present, may be the same or different, and are preferably the same.

y12 is preferably 1 or 3.

Examples of the group represented by formula (c11-2) include groups represented by formula (s3-11).

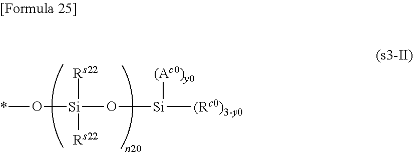

TABLE 3

| | A^{c0} | R^{s22} | n20 | y0 | R^{c0} |
|---|---|---|---|---|---|
| (s3-II-1) | C₂H₅O—* | CH₃—* | 1~30 | 1 | CH₃—* |
| (s3-II-2) | CH₃O—* | CH₃—* | 1~30 | 1 | CH₃—* |
| (s3-II-3) | HO—* | CH₃—* | 1~30 | 1 | CH₃—* |
| (s3-II-4) | C₂H₅O—* | CH₃—* | 1~30 | 1 | C₂H₅—* |
| (s3-II-5) | CH₃O—* | CH₃—* | 1~30 | 1 | C₂H₅—* |
| (s3-II-6) | HO—* | CH₃—* | 1~30 | 1 | C₂H₅—* |
| (s3-II-7) | C₂H₅O—* | CH₃—* | 1~30 | 2 | CH₃—* |
| (s3-II-8) | CH₃O—* | CH₃—* | 1~30 | 2 | CH₃—* |
| (s3-II-9) | HO—* | CH₃—* | 1~30 | 2 | CH₃—* |
| (s3-II-10) | C₂H₅O—* | CH₃—* | 1~30 | 2 | C₂H₅—* |
| (s3-II-11) | CH₃O—* | CH₃—* | 1~30 | 2 | C₂H₅—* |
| (s3-II-12) | HO—* | CH₃—* | 1~30 | 2 | C₂H₅—* |
| (s3-II-13) | C₂H₅O—* | CH₃—* | 1~30 | 3 | — |
| (s3-II-14) | CH₃O—* | CH₃—* | 1~30 | 3 | — |
| (s3-II-15) | HO—* | CH₃—* | 1~30 | 3 | — |

A^{c1} in formula (c1) will be described. A^{c1} represents a hydroxy group or a hydrolyzable group. The hydrolyzable group may be a group which gives a hydroxy group (silanol group) when hydrolyzed, and preferred examples thereof include alkoxy groups having 1 to 4 carbon atoms, such as a methoxy group, an ethoxy group, a propoxy group and a butoxy group; an acetoxy group; a chlorine atom; and an isocyanate group. A^{c1} is preferably a hydroxy group or an alkoxy group having 1 to 4 carbon atoms, more preferably a hydroxy group or an alkoxy group having 1 or 2 carbon atoms. A plurality of A^{c1}s, when present, may be the same or different, and are preferably the same.

Z^{c1} in formula (c1) represents a hydrocarbon group, a trialkylsilyl group-containing molecular chain or a siloxane backbone-containing group.

When Z^{c1} is a hydrocarbon group, the number of carbon atoms thereof is preferably 1 to 4, more preferably 1 to 3, still more preferably 1 or 2. When Z^{c1} is a hydrocarbon group, an aliphatic hydrocarbon group is preferable, and an alkyl group is more preferable. Examples of the alkyl group include a methyl group, an ethyl group, a propyl group and a butyl group, and a methyl group or an ethyl group is still more preferable, with a methyl group being particularly preferable.

The trialkylsilyl group-containing molecular chain means a monovalent group having a structure in which a trialkylsilyl-containing group is bonded to an end of the molecular chain. When Z^{c1} is a trialkylsilyl group-containing molecular chain, a group of the above formula (c11-1) is preferable where when all R^{c13}s are hydrocarbon groups, the R^{c13}s are alkyl groups.

When Z^{c1} is a siloxane backbone-containing group, the siloxane backbone-containing group is preferably a monovalent group containing a siloxane unit (Si—O—) and consisting of atoms whose number is smaller than the number of atoms forming R^{c1}. This makes the siloxane backbone-containing group smaller in length or three-dimensional extent (bulkiness) than R^{c1}. The siloxane backbone-containing group may contain a divalent hydrocarbon group.

The siloxane backbone-containing group is preferably a group of the following formula (s4).

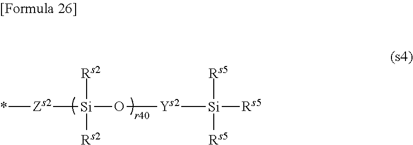

In formula (s4), R^{s2} has the same meaning as that described above. R^{s5} represents a hydrocarbon group or a hydroxy group, —CH₂— in the hydrocarbon group is optionally replaced by —O—, and hydrogen atoms in the hydrocarbon group are optionally replaced by fluorine atoms. Z^{s2} represents —O— or a divalent hydrocarbon group, and —CH₂— in the divalent hydrocarbon group is optionally replaced by —O—. Y^{s2} represents a single bond or —Si(Rₛ₂)₂-L^{s2}-. L^{s2} represents a divalent hydrocarbon group, and —CH₂— in the divalent hydrocarbon group is optionally replaced by —O—. r40 represents an integer of 0 to 5. * represents a bond to a silicon atom.

Examples of the hydrocarbon group represented by R^{s5} include groups similar to the hydrocarbon groups represented by R^{c11}, and aliphatic hydrocarbon groups are preferable, with alkyl groups being more preferable. The number of carbon atoms is preferably 1 to 4, more preferably 1 to 3, still more preferably 1 or 2.

Examples of the divalent hydrocarbon group represented by Z^{s2} or L^{s2} include groups similar to the divalent hydrocarbon groups represented by Z^{s1}, and the number of carbon atoms is preferably 1 to 10, more preferably 1 to 6, still more preferably 1 to 4. The divalent hydrocarbon group represented by Z^{s2} or L^{s2} is preferably a divalent aliphatic hydrocarbon group, more preferably a linear or branched alkanediyl group.

r40 is preferably 1 to 5, more preferably 1 to 3.

The total number of atoms in the siloxane backbone-containing group is preferably 100 or less, more preferably 50 or less, still more preferably 30 or less, and preferably 10 or more. The difference between the number of atoms in R^{s1} and the number of atoms in the siloxane backbone-containing group is 10 or more, more preferably 20 or more, and preferably 1000 or less, more preferably 500 or less, still more preferably 200 or less.

Specific examples of the siloxane backbone-containing group include groups of the following formulae.

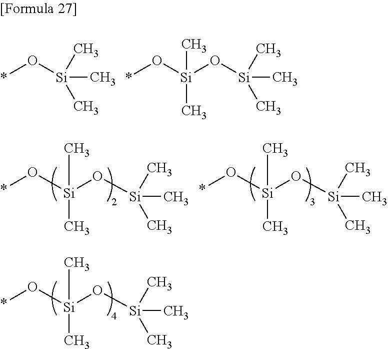

r1 in formula (c1) represents an integer of 1 to 3, preferably 1 or 3, more preferably 3.

Examples of the compound (C1) include compounds of the following formula (c1-1), i.e. compounds in which R^{c1} in formula (c1) is a group represented by formula (c11-1) and r1 in formula (c1) is 3.

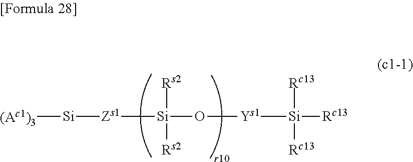

In formula (c1-1), A^{c1}, Y^{s1}, Z^{s1}, R^{s2}, R^{c13} and r10 have the same meanings as those described above.

In particular, a compound of the following formula (I-1) is preferable, and a compound represented by formula (I-1-1) is more preferable.

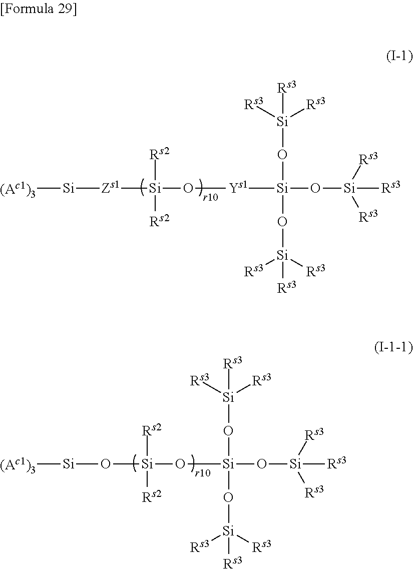

In formulae (I-1) and (I-1-1), A^{c1}, Y^{s1}, Z^{s1}, R^{s2}, R^{s3} and r10 have the same meanings as those described above.

The compound represented by formula (c1-1) may be a compound represented by formula (I-2), and is preferably a compound represented by formula (I-2-1)

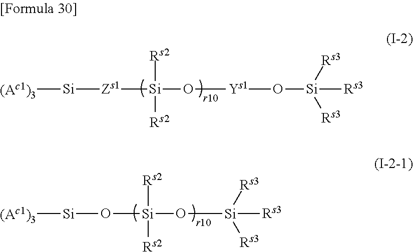

In formulae (I-2) and (I-2-1), A^{c1}, Y^{s1}, Z^{s1}, R^{s2}, R^{s3} and r10 have the same meanings as those described above.

The compound represented by formula (c1-1) is preferably a compound represented by formula (I-1-1) or formula (I-2-1).

Specific examples of the compound represented by formula (c1-1) include compounds represented by formula (I-I).

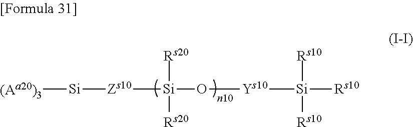

TABLE 4-1

| | A^{a20} | Z^{s10} | R^{s20} | n10 | Y^{s10} | R^{s10} |
|---|---|---|---|---|---|---|
| (I-I-1) | C₂H₅O—* | *—O—* | CH₃—* | 1~30 | — | (CH₃)₃SiO—* |
| (I-I-2) | C₂H₅O—* | *—O—* | CH₃—* | 1~30 | *—Si(CH₃)₂—CH₂—* | (CH₃)₃SiO—* |
| (I-I-3) | C₂H₅O—* | *—O—* | CH₃—* | 1~30 | *—Si(CH₃)₂—(CH₂)₂—* | (CH₃)₃SiO—* |
| (I-I-4) | C₂H₅O—* | *—O—* | CH₃—* | 1~30 | *—Si(CH₃)₂—(CH₂)₃—* | (CH₃)₃SiO—* |
| (I-I-5) | C₂H₅O—* | *—O—* | CH₃—* | 1~30 | *—Si(CH₃)₂—(CH₂)₄—* | (CH₃)₃SiO—* |
| (I-I-6) | C₂H₅O—* | *—CH₂—* | CH₃—* | 1~30 | — | (CH₃)₃SiO—* |
| (I-I-7) | C₂H₅O—* | *—CH₂—* | CH₃—* | 1~30 | *—Si(CH₃)₂—CH₂—* | (CH₃)₃SiO—* |
| (I-I-8) | C₂H₅O—* | *—CH₂—* | CH₃—* | 1~30 | *—Si(CH₃)₂—(CH₂)₂—* | (CH₃)₃SiO—* |
| (I-I-9) | C₂H₅O—* | *—CH₂—* | CH₃—* | 1~30 | *—Si(CH₃)₂—(CH₂)₃—* | (CH₃)₃SiO—* |
| (I-I-10) | C₂H₅O—* | *—CH₂—* | CH₃—* | 1~30 | *—Si(CH₃)₂—(CH₂)₄—* | (CH₃)₃SiO—* |
| (I-I-11) | C₂H₅O—* | *—(CH₂)₂—* | CH₃—* | 1~30 | — | (CH₃)₃SiO—* |
| (I-I-12) | C₂H₅O—* | *—(CH₂)₂—* | CH₃—* | 1~30 | *—Si(CH₃)₂—CH₂—* | (CH₃)₃SiO—* |
| (I-I-13) | C₂H₅O—* | *—(CH₂)₂—* | CH₃—* | 1~30 | *—Si(CH₃)₂—(CH₂)₂—* | (CH₃)₃SiO—* |
| (I-I-14) | C₂H₅O—* | *—(CH₂)₂—* | CH₃—* | 1~30 | *—Si(CH₃)₂—(CH₂)₃—* | (CH₃)₃SiO—* |
| (I-I-15) | C₂H₅O—* | *—(CH₂)₂—* | CH₃—* | 1~30 | *—Si(CH₃)₂—(CH₂)₄—* | (CH₃)₃SiO—* |
| (I-I-16) | C₂H₅O—* | *—(CH₂)₃—* | CH₃—* | 1~30 | — | (CH₃)₃SiO—* |
| (I-I-17) | C₂H₅O—* | *—(CH₂)₃—* | CH₃—* | 1~30 | *—Si(CH₃)₂—CH₂—* | (CH₃)₃SiO—* |
| (I-I-18) | C₂H₅O—* | *—(CH₂)₃—* | CH₃—* | 1~30 | *—Si(CH₃)₂—(CH₂)₂—* | (CH₃)₃SiO—* |
| (I-I-19) | C₂H₅O—* | *—(CH₂)₃—* | CH₃—* | 1~30 | *—Si(CH₃)₂—(CH₂)₃—* | (CH₃)₃SiO—* |
| (I-I-20) | C₂H₅O—* | *—(CH₂)₃—* | CH₃—* | 1~30 | *—Si(CH₃)₂—(CH₂)₄—* | (CH₃)₃SiO—* |
| (I-I-21) | C₂H₅O—* | *—(CH₂)₄—* | CH₃—* | 1~30 | — | (CH₃)₃SiO—* |
| (I-I-22) | C₂H₅O—* | *—(CH₂)₄—* | CH₃—* | 1~30 | *—Si(CH₃)₂—CH₂—* | (CH₃)₃SiO—* |
| (I-I-23) | C₂H₅O—* | *—(CH₂)₄—* | CH₃—* | 1~30 | *—Si(CH₃)₂—(CH₂)₂—* | (CH₃)₃SiO—* |
| (I-I-24) | C₂H₅O—* | *—(CH₂)₄—* | CH₃—* | 1~30 | *—Si(CH₃)₂—(CH₂)₃—* | (CH₃)₃SiO—* |
| (I-I-25) | C₂H₅O—* | *—(CH₂)₄—* | CH₃—* | 1~30 | *—Si(CH₃)₂—(CH₂)₄—* | (CH₃)₃SiO—* |

TABLE 4-2

| | A^{a20} | Z^{s10} | R^{s20} | n10 | Y^{s10} | R^{s10} |
|---|---|---|---|---|---|---|
| (I-I-26) | CH₃O—* | *—O—* | CH₃—* | 1~30 | — | (CH₃)₃SiO—* |
| (I-I-27) | CH₃O—* | *—O—* | CH₃—* | 1~30 | *—Si(CH₃)₂—CH₂—* | (CH₃)₃SiO—* |
| (I-I-28) | CH₃O—* | *—O—* | CH₃—* | 1~30 | *—Si(CH₃)₂—(CH₂)₂—* | (CH₃)₃SiO—* |
| (I-I-29) | CH₃O—* | *—O—* | CH₃—* | 1~30 | *—Si(CH₃)₂—(CH₂)₃—* | (CH₃)₃SiO—* |
| (I-I-30) | CH₃O—* | *—O—* | CH₃—* | 1~30 | *—Si(CH₃)₂—(CH₂)₄—* | (CH₃)₃SiO—* |
| (I-I-31) | CH₃O—* | *—CH₂—* | CH₃—* | 1~30 | — | (CH₃)₃SiO—* |
| (I-I-32) | CH₃O—* | *—CH₂—* | CH₃—* | 1~30 | *—Si(CH₃)₂—CH₂—* | (CH₃)₃SiO—* |
| (I-I-33) | CH₃O—* | *—CH₂—* | CH₃—* | 1~30 | *—Si(CH₃)₂—(CH₂)₂—* | (CH₃)₃SiO—* |
| (I-I-34) | CH₃O—* | *—CH₂—* | CH₃—* | 1~30 | *—Si(CH₃)₂—(CH₂)₃—* | (CH₃)₃SiO—* |
| (I-I-35) | CH₃O—* | *—CH₂—* | CH₃—* | 1~30 | *—Si(CH₃)₂—(CH₂)₄—* | (CH₃)₃SiO—* |
| (I-I-36) | CH₃O—* | *—(CH₂)₂—* | CH₃—* | 1~30 | — | (CH₃)₃SiO—* |
| (I-I-37) | CH₃O—* | *—(CH₂)₂—* | CH₃—* | 1~30 | *—Si(CH₃)₂—CH₂—* | (CH₃)₃SiO—* |
| (I-I-38) | CH₃O—* | *—(CH₂)₂—* | CH₃—* | 1~30 | *—Si(CH₃)₂—(CH₂)₂—* | (CH₃)₃SiO—* |
| (I-I-39) | CH₃O—* | *—(CH₂)₂—* | CH₃—* | 1~30 | *—Si(CH₃)₂—(CH₂)₃—* | (CH₃)₃SiO—* |
| (I-I-40) | CH₃O—* | *—(CH₂)₂—* | CH₃—* | 1~30 | *—Si(CH₃)₂—(CH₂)₄—* | (CH₃)₃SiO—* |
| (I-I-41) | CH₃O—* | *—(CH₂)₃—* | CH₃—* | 1~30 | — | (CH₃)₃SiO—* |
| (I-I-42) | CH₃O—* | *—(CH₂)₃—* | CH₃—* | 1~30 | *—Si(CH₃)₂—CH₂—* | (CH₃)₃SiO—* |
| (I-I-43) | CH₃O—* | *—(CH₂)₃—* | CH₃—* | 1~30 | *—Si(CH₃)₂—(CH₂)₂—* | (CH₃)₃SiO—* |
| (I-I-44) | CH₃O—* | *—(CH₂)₃—* | CH₃—* | 1~30 | *—Si(CH₃)₂—(CH₂)₃—* | (CH₃)₃SiO—* |
| (I-I-45) | CH₃O—* | *—(CH₂)₃—* | CH₃—* | 1~30 | *—Si(CH₃)₂—(CH₂)₄—* | (CH₃)₃SiO—* |
| (I-I-46) | CH₃O—* | *—(CH₂)₄—* | CH₃—* | 1~30 | — | (CH₃)₃SiO—* |
| (I-I-47) | CH₃O—* | *—(CH₂)₄—* | CH₃—* | 1~30 | *—Si(CH₃)₂—CH₂—* | (CH₃)₃SiO—* |
| (I-I-48) | CH₃O—* | *—(CH₂)₄—* | CH₃—* | 1~30 | *—Si(CH₃)₂—(CH₂)₂—* | (CH₃)₃SiO—* |
| (I-I-49) | CH₃O—* | *—(CH₂)₄—* | CH₃—* | 1~30 | *—Si(CH₃)₂—(CH₂)₃—* | (CH₃)₃SiO—* |
| (I-I-50) | CH₃O—* | *—(CH₂)₄—* | CH₃—* | 1~30 | *—Si(CH₃)₂—(CH₂)₄—* | (CH₃)₃SiO—* |

TABLE 5-1

| | A^{a10} | Z^{s10} | R^{s20} | n10 | Y^{s10} | R^{s10} |
|---|---|---|---|---|---|---|
| (I-I-51) | C₂H₅O—* | *—O—* | CH₃—* | 1~30 | — | CH₃—* |
| (I-I-52) | C₂H₅O—* | *—O—* | CH₃—* | 1~30 | *—Si(CH₃)₂—CH₂—* | CH₃—* |
| (I-I-53) | C₂H₅O—* | *—O—* | CH₃—* | 1~30 | *—Si(CH₃)₂—(CH₂)₂—* | CH₃—* |
| (I-I-54) | C₂H₅O—* | *—O—* | CH₃—* | 1~30 | *—Si(CH₃)₂—(CH₂)₃—* | CH₃—* |
| (I-I-55) | C₂H₅O—* | *—O—* | CH₃—* | 1~30 | *—Si(CH₃)₂—(CH₂)₄—* | CH₃—* |
| (I-I-56) | C₂H₅O—* | *—CH₂—* | CH₃—* | 1~30 | — | CH₃—* |
| (I-I-57) | C₂H₅O—* | *—CH₂—* | CH₃—* | 1~30 | *—Si(CH₃)₂—CH₂—* | CH₃—* |
| (I-I-58) | C₂H₅O—* | *—CH₂—* | CH₃—* | 1~30 | *—Si(CH₃)₂—(CH₂)₂—* | CH₃—* |
| (I-I-59) | C₂H₅O—* | *—CH₂—* | CH₃—* | 1~30 | *—Si(CH₃)₂—(CH₂)₃—* | CH₃—* |
| (I-I-60) | C₂H₅O—* | *—CH₂—* | CH₃—* | 1~30 | *—Si(CH₃)₂—(CH₂)₄—* | CH₃—* |
| (I-I-61) | C₂H₅O—* | *—(CH₂)₂—* | CH₃—* | 1~30 | — | CH₃—* |
| (I-I-62) | C₂H₅O—* | *—(CH₂)₂—* | CH₃—* | 1~30 | *—Si(CH₃)₂—CH₂—* | CH₃—* |
| (I-I-63) | C₂H₅O—* | *—(CH₂)₂—* | CH₃—* | 1~30 | *—Si(CH₃)₂—(CH₂)₂—* | CH₃—* |
| (I-I-64) | C₂H₅O—* | *—(CH₂)₂—* | CH₃—* | 1~30 | *—Si(CH₃)₂—(CH₂)₃—* | CH₃—* |
| (I-I-65) | C₂H₅O—* | *—(CH₂)₂—* | CH₃—* | 1~30 | *—Si(CH₃)₂—(CH₂)₄—* | CH₃—* |
| (I-I-66) | C₂H₅O—* | *—(CH₂)₃—* | CH₃—* | 1~30 | — | CH₃—* |
| (I-I-67) | C₂H₅O—* | *—(CH₂)₃—* | CH₃—* | 1~30 | *—Si(CH₃)₂—CH₂—* | CH₃—* |
| (I-I-68) | C₂H₅O—* | *—(CH₂)₃—* | CH₃—* | 1~30 | *—Si(CH₃)₂—(CH₂)₂—* | CH₃—* |
| (I-I-69) | C₂H₅O—* | *—(CH₂)₃—* | CH₃—* | 1~30 | *—Si(CH₃)₂—(CH₂)₃—* | CH₃—* |
| (I-I-70) | C₂H₅O—* | *—(CH₂)₃—* | CH₃—* | 1~30 | *—Si(CH₃)₂—(CH₂)₄—* | CH₃—* |
| (I-I-71) | C₂H₅O—* | *—(CH₂)₄—* | CH₃—* | 1~30 | — | CH₃—* |
| (I-I-72) | C₂H₅O—* | *—(CH₂)₄—* | CH₃—* | 1~30 | *—Si(CH₃)₂—CH₂—* | CH₃—* |
| (I-I-73) | C₂H₅O—* | *—(CH₂)₄—* | CH₃—* | 1~30 | *—Si(CH₃)₂—(CH₂)₂—* | CH₃—* |
| (I-I-74) | C₂H₅O—* | *—(CH₂)₄—* | CH₃—* | 1~30 | *—Si(CH₃)₂—(CH₂)₃—* | CH₃—* |
| (I-I-75) | C₂H₅O—* | *—(CH₂)₄—* | CH₃—* | 1~30 | *—Si(CH₃)₂—(CH₂)₄—* | CH₃—* |

TABLE 5-2

| | A^{a10} | Z^{s10} | R^{s20} | n10 | Y^{s10} | R^{s10} |
|---|---|---|---|---|---|---|
| (I-I-76) | CH₃O—* | *—O—* | CH₃—* | 1~30 | — | CH₃—* |
| (I-I-77) | CH₃O—* | *—O—* | CH₃—* | 1~30 | *—Si(CH₃)₂—CH₂—* | CH₃—* |
| (I-I-78) | CH₃O—* | *—O—* | CH₃—* | 1~30 | *—Si(CH₃)₂—(CH₂)₂—* | CH₃—* |
| (I-I-79) | CH₃O—* | *—O—* | CH₃—* | 1~30 | *—Si(CH₃)₂—(CH₂)₃—* | CH₃—* |
| (I-I-80) | CH₃O—* | *—O—* | CH₃—* | 1~30 | *—Si(CH₃)₂—(CH₂)₄—* | CH₃—* |
| (I-I-81) | CH₃O—* | *—CH₂—* | CH₃—* | 1~30 | — | CH₃—* |
| (I-I-82) | CH₃O—* | *—CH₂—* | CH₃—* | 1~30 | *—Si(CH₃)₂—CH₂—* | CH₃—* |
| (I-I-83) | CH₃O—* | *—CH₂—* | CH₃—* | 1~30 | *—Si(CH₃)₂—(CH₂)₂—* | CH₃—* |
| (I-I-84) | CH₃O—* | *—CH₂—* | CH₃—* | 1~30 | *—Si(CH₃)₂—(CH₂)₃—* | CH₃—* |
| (I-I-86) | CH₃O—* | *—CH₂—* | CH₃—* | 1~30 | *—Si(CH₃)₂—(CH₂)₄—* | CH₃—* |
| (I-I-86) | CH₃O—* | *—(CH₂)₂—* | CH₃—* | 1~30 | — | CH₃—* |
| (I-I-87) | CH₃O—* | *—(CH₂)₂—* | CH₃—* | 1~30 | *—Si(CH₃)₂—CH₂—* | CH₃—* |
| (I-I-88) | CH₃O—* | *—(CH₂)₂—* | CH₃—* | 1~30 | *—Si(CH₃)₂—(CH₂)₂—* | CH₃—* |
| (I-I-89) | CH₃O—* | *—(CH₂)₂—* | CH₃—* | 1~30 | *—Si(CH₃)₂—(CH₂)₃—* | CH₃—* |
| (I-I-90) | CH₃O—* | *—(CH₂)₂—* | CH₃—* | 1~30 | *—Si(CH₃)₂—(CH₂)₄—* | CH₃—* |
| (I-I-91) | CH₃O—* | *—(CH₂)₃—* | CH₃—* | 1~30 | — | CH₃—* |
| (I-I-92) | CH₃O—* | *—(CH₂)₃—* | CH₃—* | 1~30 | *—Si(CH₃)₂—CH₂—* | CH₃—* |
| (I-I-93) | CH₃O—* | *—(CH₂)₃—* | CH₃—* | 1~30 | *—Si(CH₃)₂—(CH₂)₂—* | CH₃—* |
| (I-I-94) | CH₃O—* | *—(CH₂)₃—* | CH₃—* | 1~30 | *—Si(CH₃)₂—(CH₂)₃—* | CH₃—* |
| (I-I-95) | CH₃O—* | *—(CH₂)₃—* | CH₃—* | 1~30 | *—Si(CH₃)₂—(CH₂)₄—* | CH₃—* |
| (I-I-96) | CH₃O—* | *—(CH₂)₄—* | CH₃—* | 1~30 | — | CH₃—* |
| (I-I-97) | CH₃O—* | *—(CH₂)₄—* | CH₃—* | 1~30 | *—Si(CH₃)₂—CH₂—* | CH₃—* |
| (I-I-98) | CH₃O—* | *—(CH₂)₄—* | CH₃—* | 1~30 | *—Si(CH₃)₂—(CH₂)₂—* | CH₃—* |
| (I-I-99) | CH₃O—* | *—(CH₂)₄—* | CH₃—* | 1~30 | *—Si(CH₃)₂—(CH₂)₃—* | CH₃—* |
| (I-I-100) | CH₃O—* | *—(CH₂)₄—* | CH₃—* | 1~30 | *—Si(CH₃)₂—(CH₂)₄—* | CH₃—* |

Among compounds of the above formula (I-I), compounds represented by formula (I-I-26) are more preferable. That is, as the compound (C1), compounds of the following formula (c1-I) are preferable.

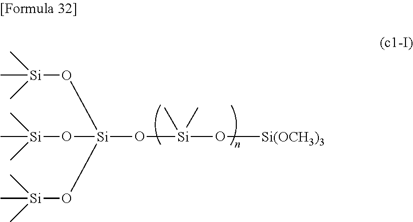

In formula (c1-1), n represents an integer of 1 to 30.

Examples of the method for synthesizing the compound represented by formula (c1-1) include a method described in Japanese Patent Laid-Open No. 2017-201009.

Examples of the compound (C1) also include compounds represented by formula (c1-2), i.e. compounds in which R^{c1} in formula (c1) is a group represented by formula (c11-2) and Z^{c1} in formula (c1) is a hydrocarbon group.

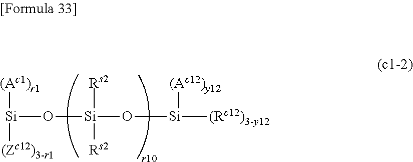

In formula (c1-2), A^{c1}, R^{s2}, A^{c12}, R^{c2}, r1, r10 and y12 have the same meanings as those described above, Z^{c12} represents a hydrocarbon group, and a plurality of Z^{c12}s, when present, are optionally different from each other.

In formula (c1-2), A^{c1} and A^{c12} are each preferably a hydroxy group or an alkoxy group having 1 to 4 carbon atoms, more preferably a hydroxy group or an alkoxy group having 1 or 2 carbon atoms. A^{c1} and A^{c12} may be the same or different, and are preferably the same.

Examples of the hydrocarbon group represented by Z^{c12} include those similar to the groups described for Z^{c1} above, a methyl group or an ethyl group is preferable, with a methyl group being more preferable. Z^{c12} and R^{c12} may be the same or different, and are preferably the same.

r1 and y12 are each preferably 1 or 3. r1 and y12 may be the same or different, and are preferably the same.

As the compound represented by formula (c1-2), a compound is preferably used where R^{s2} is a methyl group, r10 represents an integer of 1 to 30, each of A^{c1} and A^{c12} is an alkoxy group having 1 or 2 carbon atoms, or a hydroxy group, each of Z^{c12} and R^{c12} is a methyl group or an ethyl group, and r1 and y12 are the same, and each represent an integer of 1 to 3.

Specific examples of the compound represented by formula (c1-2) include compounds represented by formula (I-II).

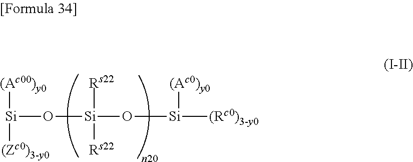

TABLE 6

| | A^{c00} | Z^{c0} | R^{s22} | n20 | y0 | A^{c0} | R^{c0} |
|---|---|---|---|---|---|---|---|
| (I-II-1) | C₂H₅O—* | CH₃—* | CH₃—* | 1~30 | 1 | C₂H₅O—* | CH₃—* |
| (I-II-2) | CH₃O—* | CH₃—* | CH₃—* | 1~30 | 1 | CH₃O—* | CH₃—* |
| (I-II-3) | HO—* | CH₃—* | CH₃—* | 1~30 | 1 | HO—* | CH₃—* |
| (I-II-4) | C₂H₅O—* | C₂H₅—* | CH₃—* | 1~30 | 1 | C₂H₅O—* | C₂H₅—* |
| (I-II-5) | CH₃O—* | C₂H₅—* | CH₃—* | 1~30 | 1 | CH₃O—* | C₂H₅—* |
| (I-II-6) | HO—* | C₂H₅—* | CH₃—* | 1~30 | 1 | HO—* | C₂H₅—* |
| (I-II-7) | C₂H₅O—* | CH₃—* | CH₃—* | 1~30 | 2 | C₂H₅O—* | CH₃—* |
| (I-II-8) | CH₃O—* | CH₃—* | CH₃—* | 1~30 | 2 | CH₃O—* | CH₃—* |
| (I-II-9) | HO—* | CH₃—* | CH₃—* | 1~30 | 2 | HO—* | CH₃—* |
| (I-II-10) | C₂H₅O—* | C₂H₅—* | CH₃—* | 1~30 | 2 | C₂H₅O—* | C₂H₅—* |
| (I-II-11) | CH₃O—* | C₂H₅—* | CH₃—* | 1~30 | 2 | CH₃O—* | C₂H₅—* |
| (I-II-12) | HO—* | C₂H₅—* | CH₃—* | 1~30 | 2 | HO—* | C₂H₅—* |
| (I-II-13) | C₂H₅O—* | — | CH₃—* | 1~30 | 3 | C₂H₅O—* | — |
| (I-II-14) | CH₃O—* | — | CH₃—* | 1~30 | 3 | CH₃O—* | — |
| (I-II-15) | HO—* | — | CH₃—* | 1~30 | 3 | HO—* | — |

As the compound represented by formula (c1-2), compounds (I-II-1) to (I-II-3) and (I-II-13) to (I-II-15) are preferable, and the compound (I-II-3), the compound (I-II-13) or the compound (I-II-14) is more preferable.

The compound (C1) is preferably a compound of the above (c1-1) or a compound represented by formula (c1-2).

When the curing inhibitor (C) comprises the compound (C1), the compound (C1) is present at preferably 50 mass % or more, more preferably 70 mass % or more, still more preferably 90 mass % or more, particularly preferably 100 mass % or more, per 100 mass % of the curing inhibitor (C).

The mass ratio (C1/(A+B)) of the compound (C1) to the total amount of the organosilicon compound (A) and the organosilicon compound (B) is preferably 0.6 or less, more preferably 0.1 or less, still more preferably 0.08 or less, and preferably 0.0001 or more, more preferably 0.0005 or more, still more preferably 0.001 or more.

The molar ratio (C1/(A+B)) of the compound (C1) to the total amount of the organosilicon compound (A) and the organosilicon compound (B) is preferably 0.00001 or more, more preferably 0.00005 or more, still more preferably 0.0001 or more, and preferably 0.1 or less, more preferably 0.05 or less, still more preferably 0.01 or less.

Where the total amount of the composition is 100 mass %, the amount of the compound (C1) is preferably 5 mass % or less, more preferably 1 mass % or less, still more preferably 0.5 mass % or less, particularly preferably 0.1 mass % or less, and preferably 0.00001 mass % or more, more preferably 0.00005 mass % or more, still more preferably 0.0001 mass % or more.

### 3-2. Compound (C2)

It is also preferable that the curing inhibitor (C) comprise a compound represented by formula (c2) (hereinafter, sometimes referred to as a compound (C2)).

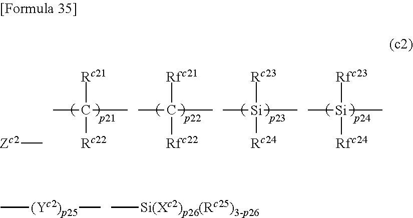

In formula (c2),

R^{c21}, R^{c22}, R^{c23} and R^{c24} are each independently a hydrogen atom or an alkyl group having 1 to 4 carbon atoms, a plurality of R^{c21}s, when present, are optionally different from each other, a plurality of R^{c22}s, when present, are optionally different from each other, a plurality of R^{c23}s, when present, are optionally different from each other, and a plurality of R^{c24}s, when present, are optionally different from each other; Rf^{c21}, Rf^{c22}, Rf^{c23} and Rf^{c24} are each independently an alkyl group having 1 to 20 carbon atoms with one or more hydrogen atoms replaced by fluorine atoms, or a fluorine atom, a plurality of Rf^{c21}s, when present, are optionally different from each other, a plurality of Rf^{c22}s, when present, are optionally different from each other, a plurality of Rf^{c23}s, when present, are optionally different from each other, and a plurality of Rf^{c24}s, when present, are optionally different from each other; R^{c25} is an alkyl group having 1 to 20 carbon atoms, and a plurality of R^{c2}=s, when present, are optionally different from each other;

X^{c2} is a hydrolyzable group, and a plurality of X^{c2}s, when present, are optionally different from each other;

Y^{c2} is —O—, —NH— or —S—, and a plurality of Y^{c2}s, when present, are optionally different from each other;

Z^{c2} is a vinyl group, an α-methylvinyl group, a styryl group, a methacryloyl group, an acryloyl group, an amino group, an isocyanate group, an isocyanurate group, an epoxy group, an ureido group or a mercapto group;

p21 is an integer of 1 to 20, p22, p23 and p24 are each independently an integer of 0 to 10, and p25 is an integer of 0 to 10;

p26 is an integer of 1 to 3; and

Z^{c2}—, —Si(X^{c2})ₚ₂₆(R^{c25})₃₋ₚ₂₆, p21-{C(R^{c21})(R^{c22})}-s, p22-{C(Rf^{c21})(Rf^{c22})}-s, p23-{Si(R^{c23})(R^{c24})}-s, p24-{Si(Rf^{c23})(Rf^{c24})}-s and p25-Y^{c2}-s are bonded in line in any order as long as Z^{c2}— and —Si(X^{c2})ₚ₂₆(R^{c25})₃₋ₚ₂₆ are at the ends and —Y^{c2}-s are not connected to each other.

R^{c21}, R^{c22}, R^{c23} and Rf^{c24} are each preferably a hydrogen atom.

Preferably, Rf^{c21}, Rf^{c22}, Rf^{c23} and Rf^{c24} are each independently an alkyl group having 1 to 10 carbon atoms with one or more hydrogen atoms replaced by fluorine atoms, or a fluorine atom.

R^{c25} is preferably an alkyl group having 1 to 5 carbon atoms.

X^{c2} is preferably an alkoxy group, a halogen group, a cyano group or an isocyanate group, more preferably an alkoxy group, still more preferably a methoxy group or an ethoxy group.

Y^{c2} is preferably —NH—.

Z^{c2} is preferably a methacryloyl group, an acryloyl group, a mercapto group or an amino group, more preferably a mercapto group or an amino group, still more preferably an amino group.

p21 is preferably 1 to 15, more preferably 2 to 10.

Preferably, p22, p23 and p24 are each independently 0 to 5. More preferably all of p22, p23 and p24 are 0 to 2.

p25 is preferably 1 to 5, more preferably 1 to 3.

p26 is preferably 2 or 3, more preferably 3.

As the compound (C2), a compound of the above formula (c2) is preferably used where each of R^{c21} and R^{c22} is a hydrogen atom, Y^{c2} is —NH—, X^{c2} is an alkoxy group (particularly a methoxy group or an ethoxy group), Z^{c2} is an amino group or a mercapto group, p21 is 1 to 10, each of p22, p23 and p24 is 0, p25 is 1 to 5 (particularly preferably 1 to 3), and p26 is 3.

N-2-(aminoethyl)-3-aminopropyltrimethoxysilane used as the compound (C2) in Examples described below is represented by the above formula (c2) where Z^{c2} is an amino group, each of R^{c21} and R^{c22} is a hydrogen atom, p21 is 5, each of p22, p23 and p24 is 0, Y^{c2} is —NH—, p25 is 1, p26 is 3, and X^{c2} is a methoxy group. N-2-(aminoethyl)-8-aminooctyltrimethoxysilane used as the compound (C2) in Examples described below is represented by the above formula (c2) where Z^{c2} is an amino group, each of R^{c21} and R^{c22} is a hydrogen atom, p21 is 10, each of p22, p23 and p24 is 0, Y^{c2} is —NH—, p25 is 1, p26 is 3, and X^{c2} is a methoxy group.

The compound (C2) is preferably a compound of the following formula (c2-1).

[Formula 36]

Z^{c21}—C_{q}H_{2q}—Y^{c21}—CᵣH₂ᵣ—Si(X^{c21})ₚ₂₇(R^{c26})₃₋ₚ₂₇ (c21)

In formula (c2-1),

X^{c2}1 is a methoxy group or an ethoxy group, and a plurality of X^{c21}s, when present, are optionally different from each other;

Y^{c21} is —NH—, —CH₂— or —O—;

Z^{c21} is an amino group or a mercapto group;

R^{c26} is an alkyl group having 1 to 20 carbon atoms, and a plurality of R^{c26}s, when present, are optionally different from each other;

p27 is an integer of 1 to 3;

q is an integer of 2 to 5; and

r is an integer of 0 to 10.

Y^{c21} is preferably —NH—.

Z^{c21} is preferably an amino group.

R^{c26} is preferably an alkyl group having 1 to 10 carbon atoms, more preferably an alkyl group having 1 to 5 carbon atoms.

p27 is preferably 2 or 3, more preferably 3.

q is preferably 2 or 3, and r is preferably an integer of 2 to 8.

When the curing inhibitor (C) comprises the compound (C2), the compound (C2) is present at preferably 50 mass % or more, more preferably 70 mass % or more, still more preferably 90 mass % or more, particularly preferably 100 mass % or more, per 100 mass % of the curing inhibitor (C).

The mass ratio (C2/(A+B)) of the compound (C2) to the total amount of the organosilicon compound (A) and the organosilicon compound (B) is preferably 0.9 or less, more preferably 0.7 or less, still more preferably 0.5 or less, furthermore preferably 0.3 or less, and preferably 0.001 or more, more preferably 0.01 or more, still more preferably 0.05 or more, furthermore preferably 0.1 or more.

The molar ratio (C2/(A+B)) of the compound (C2) to the total amount of the organosilicon compound (A) and the organosilicon compound (B) is preferably 0.001 or more, more preferably 0.01 or more, still more preferably 0.05 or more, furthermore preferably 0.08 or more and preferably 1 or less, more preferably 0.6 or less, still more preferably 0.5 or less, furthermore preferably 0.3 or less.

Where the total amount of the composition is 100 mass %, the amount of the compound (C2) is preferably 5 mass % or less, more preferably 3 mass % or less, still more preferably 1 mass % or less, particularly preferably 0.5 mass % or less, most preferably 0.02 mass % or less, and preferably 0.0001 mass % or more, more preferably 0.001 mass % or more, still more preferably 0.003 mass % or more, particularly preferably 0.004 mass % or more.

### 3-3. Compound (C3)

It is also preferable that the curing inhibitor (C) comprise a compound represented by formula (c3) (hereinafter, sometimes referred to as a compound (C3)).

[Formula 37]

(X^{c3})₃Si—R^{c3}—Si(X^{c3})₃ (c3)

In formula (c3),

a plurality of X^{c3} each independently represent a hydrolyzable group; and

R^{c3} represents an alkylene group having 1 to 24 carbon atoms, —CH₂— in the alkylene group is optionally replaced by —O—, —NH— or —S—, and hydrogen atoms in the alkylene group are optionally replaced by fluorine atoms.

Examples of the hydrolyzable group represented by X^{c3} in the above formula (c3) include groups which give a hydroxy group (silanol group) when hydrolyzed, and alkoxy groups having 1 to 6 carbon atoms, a cyano group, an acetoxy group, a chlorine atom, an isocyanate group and the like are preferable. Six X^{c3}s may be the same or different, and are preferably the same. X^{c3} is preferably an alkoxy group or a cyano group having 1 to 6 (more preferably 1 to 4) carbon atoms, more preferably an alkoxy group having 1 to 6 (more preferably 1 to 4) carbon atoms, and it is still more preferable that all X^{c3}s be alkoxy groups having 1 to 6 (more preferably 1 to 4) carbon atoms.

In the above formula (c3), R^{c3} is an alkylene group having 1 to 24 carbon atoms, and is preferably an alkylene group having 1 to 18 carbon atoms, more preferably an alkylene group having 1 to 12 carbon atoms, still more preferably an alkylene group having 2 to 8 carbon atoms. The alkylene group may be linear, branched or cyclic, and is preferably linear.

—CH₂— in the alkylene group is optionally replaced by —O—, —NH— or —S—. In this case, both two consecutive —CH₂-s are not replaced by —O—, —NH— or —S—, and —CH₂-adjacent to the Si atom is not replaced by —O—, —NH— or —S—. Examples of the group in which —CH₂— in the alkylene group is replaced by —O—, —NH— or —S— include groups of the following formulae (O-1) to (O-4), (NH-1) to (NH-4) and (S-1) to (S-4). In the following formulae, * represents a bond to a silicon atom.

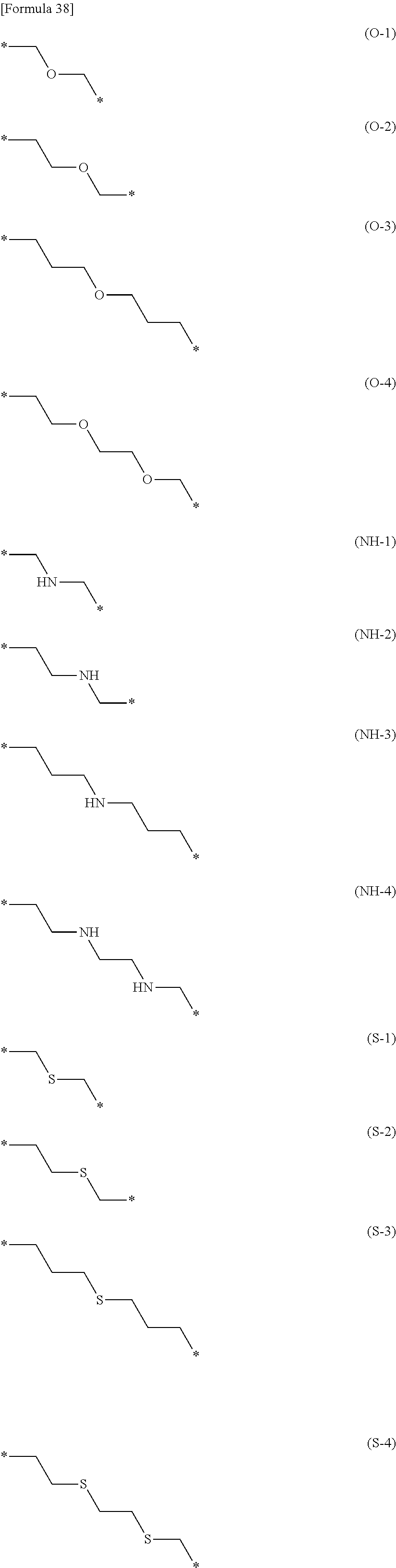

Hydrogen atoms in the alkylene group are optionally replaced by fluorine atoms, and examples of the group in which hydrogen atoms in the alkylene group are replaced by fluorine atoms include groups of the following formulae (F-1) to (F-9). In the following formulae, * represents a bond to a silicon atom.

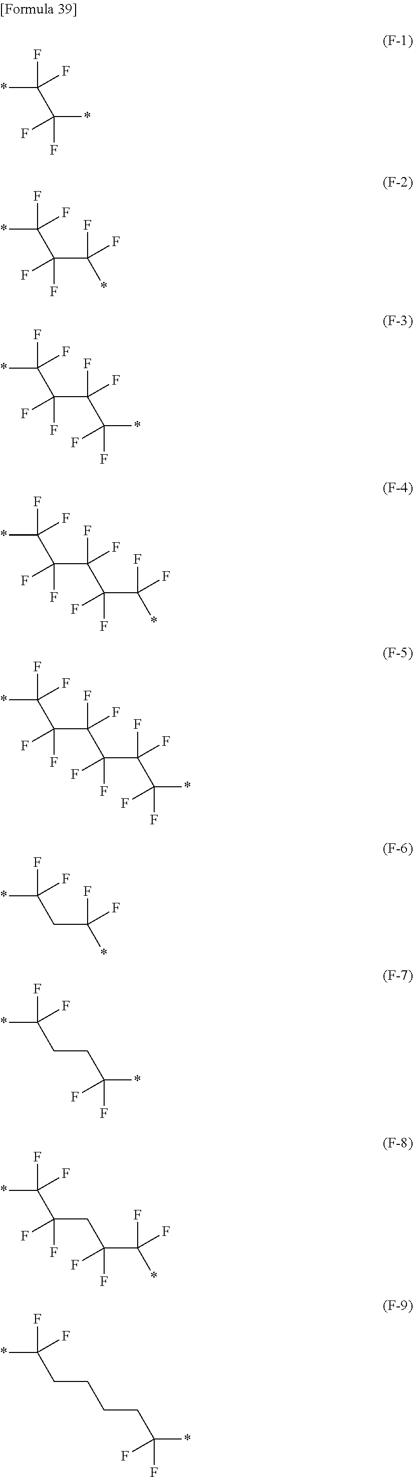

R^{c3} is preferably a group consisting only of an unsubstituted alkylene group, a group in which one of —CH₂-s in the alkylene group is replaced by —NH—, or a group in which all hydrogen atoms in the alkylene group are replaced by fluorine atoms, more preferably a group consisting only of an unsubstituted linear alkylene group, a group represented by formula (NH-3), or a group represented by formula (F-3), most preferably a group consisting only of an unsubstituted linear alkylene group.

As the compound (C3), a compound is preferably used where X^{c3} is an alkoxy group having 1 to 4 carbon atoms, and R^{c3} is a linear alkylene group having 1 to 12 carbon atoms.

The compound (C3) is more preferably a compound represented by formula (c3-1).

[Formula 40]

(X^{c31})₃Si—(CH₂)ₙ₃₀—Si(X^{c31})₃ (c3-1)

In formula (c3-1),

a plurality of X^{c31}s each independently represent a methoxy group or an ethoxy group; and

n30 represents an integer of 1 to 6.

X^{c31} is preferably a methoxy group. A plurality of X^{c21}s may be the same or different, and are preferably the same, and it is still more preferable that all of X^{c21}s be methoxy groups.

n30 is preferably an integer of 2 to 6.

Specific examples of the compound represented by formula (c3-1) include 1,2-bis(trimethoxysilyl)ethane, 1,2-bis(triethoxysilyl)ethane, 1,3-bis(trimethoxysilyl)propane, 1,3-bis(triethoxysilyl)propane, 1,4-bis(trimethoxysilyl)butane, 1,4-bis(triethoxysilyl)butane, 1,5-bis(trimethoxysilyl)pentane, 1,5-bis(triethoxysilyl)pentane, 1,6-bis(trimethoxysilyl)hexane and 1,6-bis(triethoxysilyl)hexane, and among them, 1,2-bis(trimethoxysilyl)ethane and 1,6-bis(trimethoxysilyl)hexane are preferable.

When the curing inhibitor (C) comprises the compound (C3), the compound (C3) is present at preferably 50 mass % or more, more preferably 70 mass % or more, still more preferably 90 mass % or more, particularly preferably 100 mass % or more, per 100 mass % of the curing inhibitor (C).

The mass ratio (C3/(A+B)) of the compound (C3) to the total amount of the organosilicon compound (A) and the organosilicon compound (B) is preferably 1.0 or less, more preferably 0.9 or less, still more preferably 0.7 or less, furthermore preferably 0.6 or less, and preferably 0.001 or more, more preferably 0.01 or more, still more preferably 0.05 or more, furthermore preferably 0.1 or more.

The molar ratio (C3/(A+B)) of the compound (C3) to the total amount of the organosilicon compound (A) and the organosilicon compound (B) is preferably 0.001 or more, more preferably 0.01 or more, still more preferably 0.05 or more, and preferably 1 or less, more preferably 0.8 or less, still more preferably 0.5 or less.

Where the total amount of the composition is 100 mass %, the amount of the compound (C3) is preferably 5 mass % or less, more preferably 3 mass % or less, still more preferably 1 mass % or less, particularly preferably 0.5 mass % or less, most preferably 0.1 mass % or less, and preferably 0.0001 mass % or more, more preferably 0.001 mass % or more, still more preferably 0.003 mass % or more, particularly preferably 0.004 mass % or more.

### 4. Water (D)

The second mixed composition of the present invention is capable of forming a film having a good water droplet slip drop property and good transparency not only at normal humidity but also in an environment at high humidity. For example, the mixed composition is capable of forming a film having a high water-repellent property, a good water droplet slip drop property and good transparency even at a high humidity of about 70% in terms of relative humidity.

In the second mixed composition of the present invention, the amount of water (D) may be 0.01 mass % or more, and is preferably 0.1 mass % or more, more preferably 1 mass % or more, still more preferably 2 mass % or more, furthermore preferably 3 mass % or more, furthermore preferably 5 mass % or more, particularly preferably 10 mass % or more, most preferably 20 mass % or more, and preferably 90 mass % or less, more preferably 65 mass % or less, still more preferably 60 mass % or less, furthermore preferably 50 mass % or less, where the total amount of the composition is 100 mass %.

In particular, when the curing inhibitor (C) is the compound (C1), the amount of water (D) is preferably 0.1 mass % or more, more preferably 1 mass % or more, still more preferably 3 mass % or more, furthermore preferably 5 mass % or more, particularly preferably 10 mass % or more, most preferably 20 mass % or more, and preferably 65 mass % or less, more preferably 50 mass % or less, still more preferably 40 mass % or less, furthermore preferably 35 mass % or less, where the total amount of the composition is 100 mass %.

In particular, when the curing inhibitor (C) is the compound (C2), the amount of water (D) is preferably 0.01 mass % or more, more preferably 0.1 mass % or more, still more preferably 1 mass % or more, furthermore preferably 3 mass % or more, furthermore preferably 5 mass % or more, particularly preferably 10 mass % or more, most preferably 20 mass % or more, and preferably 90 mass % or less, more preferably 70 mass % or less, still more preferably 60 mass % or less, furthermore preferably 50 mass % or less, where the total amount of the composition is 100 mass %.

In particular, when the curing inhibitor (C) is the compound (C3), the amount of water (D) is preferably 0.01 mass % or more, more preferably 0.1 mass % or more, still more preferably 1 mass % or more, furthermore preferably 3 mass % or more, furthermore preferably 5 mass % or more, particularly preferably 10 mass % or more, most preferably 20 mass % or more, and preferably 90 mass % or less, more preferably 70 mass % or less, still more preferably 60 mass % or less, furthermore preferably 50 mass % or less, where the total amount of the composition is 100 mass %.

The mass ratio (D/(A+B)) of water (D) to the total amount of the organosilicon compound (A) and the organosilicon compound (B) is, for example, 0.1 or more, preferably 5 or more, more preferably 10 or more, still more preferably 20 or more, particularly preferably 25 or more, and, for example, 3000 or less, preferably 2000 or less, more preferably 1500 or less, still more preferably 1200 or less. The mass ratio (D/(A+B)) of water (D) to the total amount of the organosilicon compound (A) and the organosilicon compound (B) is preferably in the above-described range regardless of the type of curing inhibitor (C) used, or is also preferably in the following range depending on the type of curing inhibitor (C) used.

When the curing inhibitor (C) is the compound (C1), the mass ratio (D/(A+B)) of water (D) to the total amount of the organosilicon compound (A) and the organosilicon compound (B) is more preferably 1700 or less, still more preferably 1000 or less, furthermore preferably 500 or less, particularly preferably 300 or less, most preferably 50 or less.

When the curing inhibitor (C) is the compound (C2), the mass ratio (D/(A+B)) of water (D) to the total amount of the organosilicon compound (A) and the organosilicon compound (B) is more preferably 100 or more, still more preferably 500 or more, particularly preferably 800 or more.

When the curing inhibitor (C) is the compound (C3), the mass ratio (D/(A+B)) of water (D) to the total amount of the organosilicon compound (A) and the organosilicon compound (B) is more preferably 100 or more, still more preferably 500 or more, particularly preferably 800 or more.

The mass ratio (C/D) of the curing inhibitor (C) to water (D) is preferably 0.000001 or more, more preferably 0.000005 or more, still more preferably 0.00001 or more, and preferably 3 or less, more preferably 1 or less, still more preferably 0.1 or less, furthermore preferably 0.01 or less, particularly preferably 0.005 or less.

In particular, when the compound (C1) is used, the mass ratio (C1/D) of the compound (C1) to water (D) is preferably 0.000001 or more, more preferably 0.000005 or more, still more preferably 0.00001 or more, particularly preferably 0.00003 or more, most preferably 0.0001 or more, and preferably 3 or less, more preferably 1 or less, still more preferably 0.1 or less, furthermore preferably 0.01 or less, particularly preferably 0.005 or less.

When the compound (C2) is used, the mass ratio (C2/D) of the compound (C2) to water (D) is preferably 0.000005 or more, more preferably 0.00001 or more, still more preferably 0.00005 or more, particularly preferably 0.00008 or more, most preferably 0.0001 or more, and preferably 1 or less, more preferably 0.1 or less, still more preferably 0.01 or less, furthermore preferably 0.005 or less, particularly preferably 0.001 or less, most preferably 0.0005 or less.

When the compound (C3) is used, the mass ratio (C3/D) of the compound (C3) to water (D) is preferably 0.00001 or more, more preferably 0.00005 or more, still more preferably 0.00008 or more, particularly preferably 0.0001 or more, and preferably 1 or less, more preferably 0.8 or less, still more preferably 0.1 or less, furthermore preferably 0.01 or less, furthermore preferably 0.005 or less, particularly preferably 0.001 or less, most preferably 0.0008 or less.

The first mixed composition of the present invention is a composition in which the organosilicon compound (A), the organosilicon compound (B) and the curing inhibitor (C) are mixed, and the first mixed composition is obtained by mixing these components (A) to (C).

The second mixed composition of the present invention is a composition in which the organosilicon compound (A), the organosilicon compound (B), the curing inhibitor (C) and water (D) are mixed, and the second mixed composition is obtained by mixing these components (A) to (D).

It is preferable that in the first and second mixed compositions, at least one of a solvent (E), a catalyst (F) and a carboxylic acid compound (G) be mixed in addition to the above-described components.

### 5. Solvent (E)

Examples of the solvent (E) include hydrophilic organic solvents such as alcohol-based solvents, ether-based solvents, ketone-based solvents, ester-based solvents and amide-based solvents. These solvents may be used alone, or used in combination of two or more thereof.

Examples of the alcohol-based solvent include ethanol, 1-propanol, 2-propanol, butanol, ethylene glycol, propylene glycol and diethylene glycol. Examples of the ether-based solvent include dimethoxyethane and dioxane. Examples of the ketone-based solvent include methyl isobutyl ketone, examples of the ester-based solvent include ethyl acetate and butyl acetate, and examples of the amide-based solvent include dimethylformamide. In particular, the solvent (E) is preferably an alcohol-based solvent, more preferably 2-propanol or ethanol. The solvent can be adjusted according to the material of a base material described later. For example, it is preferable to use a ketone-based solvent when a base material of an organic material is used, and it is preferable to use an alcohol-based solvent when a base material of an inorganic material is used.

Where the total amount of the composition is 100 mass %, the amount of the solvent (E) is preferably 10 mass % or more, more preferably 20 mass % or more, still more preferably 30 mass % or more, particularly preferably 40 mass % or more, and preferably 95 mass % or less, more preferably 90 mass % or less, still more preferably 85 mass % or less, furthermore preferably 80 mass % or less.

The mass ratio (E/(A+B)) of the solvent (E) to the total amount of the organosilicon compound (A) and the organosilicon compound (B) is, for example, 10 or more, preferably 30 or more, more preferably 50 or more, still more preferably 70 or more, particularly preferably 85 or more, and, for example, 3000 or less, preferably 2500 or less, more preferably 2000 or less, still more preferably 1500 or less, particularly preferably 1200 or less. The mass ratio (E/(A+B)) of the solvent (E) to the total amount of the organosilicon compound (A) and the organosilicon compound (B) is preferably in the above-described range regardless of the type of curing inhibitor (C) used, or in the following range depending on the type of curing inhibitor (C) used.

In particular, when the curing inhibitor (C) is the compound (C1), the mass ratio (E/(A+B)) of the solvent (E) to the total amount of the organosilicon compound (A) and the organosilicon compound (B) is more preferably 1100 or less, still more preferably 500 or less, particularly preferably 300 or less, most preferably 100 or less.

When the curing inhibitor (C) is the compound (C2), the mass ratio (E/(A+B)) of the solvent (E) to the total amount of the organosilicon compound (A) and the organosilicon compound (B) is more preferably 100 or more, still more preferably 500 or more, particularly preferably 800 or more.

When the curing inhibitor (C) is the compound (C3), the mass ratio (E/(A+B)) of the solvent (E) to the total amount of the organosilicon compound (A) and the organosilicon compound (B) is more preferably 100 or more, still more preferably 500 or more, particularly preferably 800 or more.

The mass ratio (C/E) of the curing inhibitor (C) to the solvent (E) is preferably 0.000001 or more, more preferably 0.000005 or more, still more preferably 0.000008 or more, particularly preferably 0.00001 or more, most preferably 0.0001 or more, and preferably 0.1 or less, more preferably 0.01 or less, still more preferably 0.005 or less, furthermore preferably 0.001 or less, particularly preferably 0.0008 or less.

In particular, when the compound (C1) is used, the mass ratio (C1/E) of the compound (C1) to the solvent (E) is preferably 0.000001 or more, more preferably 0.000005 or more, still more preferably 0.000008 or more, particularly preferably 0.00001 or more, most preferably 0.0001 or more, and preferably 0.1 or less, more preferably 0.01 or less, still more preferably 0.005 or less, furthermore preferably 0.001 or less, particularly preferably 0.0008 or less.

When the compound (C2) is used, the mass ratio (C2/E) of the compound (C2) to the solvent (E) is preferably 0.000001 or more, more preferably 0.00001 or more, still more preferably 0.00005 or more, particularly preferably 0.0001 or more, and preferably 0.1 or less, more preferably 0.01 or less, still more preferably 0.005 or less, furthermore preferably 0.001 or less, particularly preferably 0.0008 or less.

When the compound (C3) is used, the mass ratio (C3/E) of the compound (C3) to the solvent (E) is preferably 0.000001 or more, more preferably 0.00001 or more, still more preferably 0.00005 or more, particularly preferably 0.0001 or more, and preferably 0.1 or less, more preferably 0.01 or less, still more preferably 0.005 or less, furthermore preferably 0.001 or less, particularly preferably 0.0008 or less.

### 6. Catalyst (F)

As the catalyst (F), inorganic acids such as hydrogen chloride (normally used in the form of hydrochloric acid), phosphoric acid and nitric acid; carboxylic acid compounds (organic acids) such as maleic acid, malonic acid, formic acid, benzoic acid, phenylethanoic acid, butanoic acid, 2-methylpropanoic acid, propanoic acid, 2,2-dimethylpropanoic acid and acetic acid; basic compounds such as ammonia and amine; organometallic compounds such as aluminum ethylacetoacetate compounds; and the like can be used. As the catalyst (F), acidic compounds such as inorganic acids and organic acids are preferably used, inorganic acids are more preferable, and hydrogen chloride is still more preferable.

The catalysts (F) may be used alone, or used in combination of two or more thereof.

The mass ratio (F/(A+B)) of the catalyst (F) to the total amount of the organosilicon compound (A) and the organosilicon compound (B) is preferably 0.00001 or more, more preferably 0.00005 or more, still more preferably 0.0001 or more, and preferably 0.03 or less, more preferably 0.02 or less, still more preferably 0.01 or less, particularly preferably 0.001 or less.

The mass ratio (C/F) of the curing inhibitor (C) to the catalyst (F) is preferably 0.001 or more, more preferably 0.1 or more, still more preferably 1 or more, and preferably 2300 or less, more preferably 2000 or less, still more preferably 1500 or less, furthermore preferably 1200 or less, particularly preferably 800 or less.

In particular, when the curing inhibitor (C) is the compound (C1), the mass ratio (C1/F) of the compound (C1) to the catalyst (F) is preferably 0.001 or more, more preferably 0.1 or more, still more preferably 1 or more, and preferably 1500 or less, more preferably 800 or less, still more preferably 500 or less, furthermore preferably 200 or less.

When the curing inhibitor (C) is the compound (C2), the mass ratio (C2/F) of the compound (C2) to the catalyst (F) is preferably 1 or more, more preferably 50 or more, still more preferably 100 or more, furthermore preferably 200 or more, and preferably 1500 or less, more preferably 1200 or less, still more preferably 1000 or less, furthermore preferably 800 or less.

When the curing inhibitor (C) is the compound (C3), the mass ratio (C3/F) of the compound (C3) to the catalyst (F) is preferably 1 or more, more preferably 50 or more, still more preferably 100 or more, furthermore preferably 200 or more, and preferably 2300 or less, more preferably 2100 or less, still more preferably 1500 or less, furthermore preferably 1200 or less.

### 7. Carboxylic Acid Compound (G)

When a catalyst other than a carboxylic acid compound is used as the catalyst (F), it is preferable to further use a carboxylic acid compound (G). This enables suppression of impairment of storage stability due to gelation of the composition.

The carboxylic acid compound (G) means a compound having at least one carboxy group, may be either a monovalent carboxylic acid compound or a polyvalent carboxylic acid compound (carboxylic acid compound having two or more carboxy groups), and is preferably a polyvalent carboxylic acid compound. The polyvalent carboxylic acid compound is more preferably oxalic acid with two carboxy groups directly bonded to each other, or a polyvalent carboxylic acid compound in which a carboxy group is bonded to each of both ends of a divalent hydrocarbon group and the main chain (longest linear chain) of the hydrocarbon group has 1 to 15 carbon atoms (more preferably 1 to 5 carbon atoms, still more preferably 1 to 4 carbon atoms, furthermore preferably 1 to 3 carbon atoms, particularly preferably 1 or 2 carbon atoms) (particularly dicarboxylic acid, tricarboxylic acid or tetracarboxylic acid). Here, the divalent hydrocarbon group may be linear or branched, may be an aliphatic hydrocarbon group or an aromatic hydrocarbon group, and may be a saturated hydrocarbon group or an unsaturated hydrocarbon group, and hydroxy groups or carboxy groups may be bonded to carbon atoms other than those at both ends of the hydrocarbon group.

Examples of the carboxylic acid compound (G) include dicarboxylic acids such as oxalic acid, malonic acid, succinic acid, maleic acid, fumaric acid, glutaric acid, adipic acid, pimelic acid, tartaric acid, malic acid, phthalic acid, itaconic acid, muconic acid, 1,4-cyclohexanedicarboxylic acid, 1,4-naphthalenedicarboxylic acid, 2,6-naphthalenedicarboxylic acid, 2,7-naphthalenedicarboxylic acid and 4,4′-biphenyldicarboxylic acid; tricarboxylic acids such as citric acid, aconitic acid, trimellitic acid, trimesic acid, biphenyl-3,4′,5-tricarboxylic acid and tricarballylic acid; and tetracarboxylic acid such as butanetetracarboxylic acid. The carboxylic acid compound (G) is more preferably oxalic acid, dicarboxylic acid with a carboxy group bonded to each of both ends of a saturated or unsaturated linear hydrocarbon group having 1 to 3 carbon atoms (particularly 1 or 2 carbon atoms), or tricarboxylic acid. Specifically, the carboxylic acid compound (G) is preferably oxalic acid, malonic acid, succinic acid, maleic acid, glutaric acid, tricarballylic acid or the like, more preferably oxalic acid, malonic acid, succinic acid, maleic acid or tricarballylic acid.

The carboxylic acid compound (G) may be a polymer having at least one carboxy group in the molecule. Examples of the polymer include polymers containing a structural unit having a carboxy group on a side chain, and the polymer may contain two or more structural units having a carboxy group on a side chain. Examples of the polymer having at least carboxy group in the molecule include (meth)acrylic polymers having a carboxy group, polyester polymers having a carboxy group, and polyolefin polymers having a carboxy group.

The molecular weight of the carboxylic acid compound (G) is preferably 1000 or less, more preferably 500 or less. The molecular weight is preferably 50 or more, more preferably 80 or more.

The carboxylic acid compound (G) is preferably a compound of the following formula (g1).

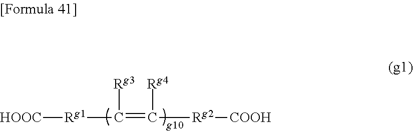

In the above formula (g1), R^{g1} and R^{g2} each independently represent a divalent aliphatic hydrocarbon group having 1 to 10 carbon atoms and optionally having a carboxy group and/or a hydroxy group, a divalent aromatic hydrocarbon group having 6 to 10 carbon atoms and optionally having a carboxy group, or a single bond. R^{g3} and R^{g4} each independently represent an alkyl group having 1 to 10 carbon atoms and optionally having a carboxy group, a carboxy group, or a hydrogen atom. g10 is 0 or 1.

The divalent aliphatic hydrocarbon group having 1 to 10 carbon atoms and represented by R^{g1} and R^{g2} may be linear, branched or cyclic. Specific examples thereof include alkanediyl groups such as a methylene group, an ethylene group, a propylene group and a butylene group.

Examples of the divalent aromatic hydrocarbon group having 6 to 10 carbon atoms and represented by R^{g3} and R^{g2} include a phenylene group.

The divalent aliphatic hydrocarbon groups represented by R^{g1} and R^{g2} optionally have a carboxy group and/or a hydroxy group, and the divalent aromatic hydrocarbon group optionally has a carboxy group.

R^{g1} is preferably a single bond, or a divalent aliphatic hydrocarbon group having 1 to 10 carbon atoms and optionally having a carboxy group, and R^{g1} is more preferably a single bond, or a divalent linear aliphatic hydrocarbon group having 1 to 10 carbon atoms and optionally having a carboxy group. R^{g2} is preferably a single bond.

The alkyl groups having 1 to 10 carbon atoms and represented by R^{g3} and R^{g4} may be linear, branched or cyclic, and specific examples thereof include a methyl group, an ethyl group, a propyl group and a butyl group.

R^{g3} is preferably a hydrogen atom. R^{g4} is preferably a hydrogen atom.

The compound of the above formula (g1) is preferably a compound of the following formula (g2). In the following formula (g2), g20 is an integer of 0 to 2.

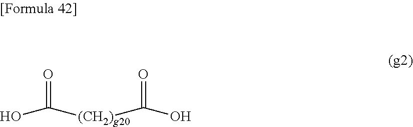

g20 is preferably 1 or 2, more preferably 1.

In the composition of the present invention, two or more of the carboxylic acid compounds (G) may be mixed.

Where the total amount of the composition is 100 mass %, the amount of the carboxylic acid compound (G) is preferably 0.00001 mass % or more, more preferably 0.00005 mass % or more, still more preferably 0.0001 mass % or more, particularly preferably 0.0005 mass % or more, most preferably 0.001 mass % or more, and preferably 3 mass % or less, more preferably 1 mass % or less, still more preferably 0.1 mass % or less, furthermore preferably 0.05 mass % or less, particularly preferably 0.03 mass % or less.

In the composition of the present invention, other components such as various additives such as oxidation inhibitors, antirust agents, ultraviolet absorbers, light stabilizers, fungicides, antibacterial agents, biofouling inhibitors, deodorants, pigments, flame retardants and antistatic agents may coexist.

The composition of the present invention can be used as a composition for producing a liquid-repellent film for impart a liquid-repellent property to a base material. That is, the composition of the present invention can be used as a liquid-repellent film forming composition.

The method for imparting a liquid-repellent property to a base material using the composition of the present invention is preferably a method in which using the composition of the present invention, a liquid-repellent film is formed on a surface of a base material to which a liquid-repellent property is desired to be imparted. As the method for forming a liquid-repellent film on a surface of a base material using the composition of the present invention, a method can be adopted in which the composition of the present invention is brought into contact with a base material, and left to stand in air in this state.

Examples of the method for bringing the composition of the present invention into contact with a base material include a spin coating method, a dip coating method, hand-coating (a method in which a cloth or the like is impregnated with a liquid and rubbed against a base material, where it is preferable to move the cloth back and forth multiple times on a substrate), pouring (a method in which a liquid is directly dropped to a base material with a dropper or the like to perform coating), spraying (a base material is coated using a spray), and combinations of these methods.

By leaving the composition of the present invention to stand in air at normal temperature (e.g. for 10 minutes to 48 hours, preferably 10 hours to 48 hours) in a state of contact with the base material, the composition can be cured to form a film on the base material. It is also preferable to further dry the obtained film. The thickness of the film is preferably 1 nm or more, more preferably 1.5 nm or more, and the upper limit thereof is, for example, 50 nm or less, and may be 20 nm or less. It is preferable that the thickness of the film be above a certain level because exhibition of a good water-repellent property with stability can be expected.

The base material which is brought into contact with the composition of the present invention may have either a planar surface shape or a curved surface shape, or may have a three-dimensional structure in which many surfaces are combined. Examples of the material of the base material include organic materials and inorganic materials. Examples of the organic material include thermoplastic resins such as acrylic resin, polycarbonate resin, polyester resin, styrene resin, acryl-styrene copolymer resin, cellulose resin and polyolefin resin; and thermosetting resins such as phenol resin, urea resin, melamine resin, epoxy resin, unsaturated polyester, silicone resin and urethane resin, and examples of the inorganic material include ceramics; glass; metals such as iron, silicon, copper, zinc and aluminum; and alloys including any of the above-described metals.

The base material may be subjected to treatment for easy bonding in advance. Examples of the treatment for easy bonding include hydrophilization treatments such as corona treatment, plasma treatment and ultraviolet treatment. Primer treatment may be performed with resin, a silane coupling agent, a tetraalkoxysilane or the like, or a glass film of polysilazane or the like may be applied to a base material in advance.

The film obtained using the composition of the present invention is excellent in liquid-repellent property (particularly water-repellent property) and slip drop property. The water-repellent property can be evaluated in accordance with a measurement method in Examples described later, and the contact angle is, for example, 100° or more, preferably 105° or more, more preferably 106° or more. The upper limit is not particularly limited, and is, for example, 120°. The slip drop property can be evaluated in accordance with a measurement method in Examples described later, and the slip drop speed is, for example, 20 mm/sec or more, preferably 50 mm/sec or more, more preferably 70 mm/sec or more, still more preferably 85 mm/sec or more. The upper limit of the slip drop speed is, for example, 150 mm/sec.

The film obtained using the composition of the present invention can maintain an excellent liquid-repellent property (particularly water-repellent property) even when used outdoors for a long period of time, and hence has excellent outdoor durability. The outdoor durability can be evaluated in accordance with a measurement method in Examples described later, and the contact angle after the durability test is, for example, 75° or more, more preferably 80° or more, still more preferably 86° or more, and the upper limit thereof is not particularly limited, and is, for example, 115°.

By using the composition of the present invention, a film excellent in outdoor durability can be provided. The film is useful for building materials, automobile parts, plant equipment and the like. In particular, by applying the composition of the present invention to glass for various vehicles and windowpanes of buildings, water-repellent articles excellent in outdoor durability can be provided, and in particular, vehicle glass at least one surface of which is provided with a film obtained from the composition of the present invention is suitably used.

### EXAMPLES

Hereinafter, the present invention will be described in detail by way of Examples. The present invention is not limited by Examples below, and can be carried out while changes are appropriately made as long as the spirits described above and later can be met, and all of these changes are encompassed in the technical scope of the present invention.

### Example 1-1

2.16×10⁻³ moles of n-decyltrimethoxysilane as the organosilicon compound (A) and 2.16×10⁻³ moles of tetraethyl orthosilicate (tetraethoxysilane) as the organosilicon compound (B) were dissolved in 2.57 ml of isopropyl alcohol (2-propanol), and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-1.

1.0 ml of the sample solution 1-1, 22.973 ml of isopropyl alcohol, 6.0 ml of water, and 0.027 ml of a solution as the curing inhibitor (C), in which a compound with the average of n10 being 24 in (I-I-26) shown in Table 4-2 above (hereinafter, referred to as a compound 1) was diluted by 100 times in terms of mass ratio with isopropyl alcohol, were mixed to prepare a coating solution 1-1.

A glass substrate of 5 cm×5 cm (soda lime glass, top surface) with a surface activated by atmospheric pressure plasma treatment was spin-coated with the obtained coating solution 1-1 under the condition of 1000 rpm and 10 sec using a spin coater (MIKASA CO., LTD, MS-A100), followed by performing drying at room temperature to obtain a film on the glass substrate.

### Example 1-2

2.16×10⁻³ moles of n-decyltrimethoxysilane as the organosilicon compound (A) and 2.16×10⁻³ moles of tetraethyl orthosilicate as the organosilicon compound (B) were dissolved in 2.57 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-2.

1.0 ml of the sample solution 1-2, 22.732 ml of isopropyl alcohol, 6.0 ml of water, and 0.268 ml of a solution as the curing inhibitor (C), in which the compound 1 was diluted by 100 times in terms of mass ratio with isopropyl alcohol, were mixed to prepare a coating solution 1-2.

A film was formed on a glass substrate in the same manner as in Example 1-1 except that the coating solution 1-2 was used.

### Example 1-3

2.16×10⁻³ moles of n-decyltrimethoxysilane as the organosilicon compound (A) and 2.16×10⁻³ moles of tetraethyl orthosilicate as the organosilicon compound (B) were dissolved in 2.57 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-3.

1.0 ml of the sample solution 1-3, 21.661 ml of isopropyl alcohol, 6.0 ml of water, and 1.339 ml of a solution as the curing inhibitor (C), in which the compound 1 was diluted by 100 times in terms of mass ratio with isopropyl alcohol, were mixed to prepare a coating solution 1-3.

A film was formed on a glass substrate in the same manner as in Example 1-1 except that the coating solution 1-3 was used.

### Example 1-4

2.16×10⁻³ moles of n-decyltrimethoxysilane as the organosilicon compound (A) and 2.16×10⁻³ moles of tetraethyl orthosilicate as the organosilicon compound (B) were dissolved in 2.57 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-4.

1.0 ml of the sample solution 1-4, 22.732 ml of isopropyl alcohol, 6.0 ml of water, and 0.268 ml of a solution as the curing inhibitor (C), in which X-24-9011 (manufactured by Shin-Etsu Chemical Co., Ltd.) was diluted by 100 times in terms of mass ratio with isopropyl alcohol, were mixed to prepare a coating solution 1-4.

A film was formed on a glass substrate in the same manner as in Example 1-1 except that the coating solution 1-4 was used.

X-24-9011 is a compound having a trimethoxysilyl group only at one end of one side and no hydroxy group and hydrolyzable group at the other end and containing a siloxane bond in the structure. The compound is represented by formula (c1) where r1 is 3, A^{c1} represents a methoxy group, and R^{c1} is a group of (c11-1), and the compound has a weight average molecular weight of 3400.

### Example 1-5

2.16×10⁻³ moles of n-decyltrimethoxysilane as the organosilicon compound (A) and 2.16×10⁻³ moles of tetraethyl orthosilicate as the organosilicon compound (B) were dissolved in 2.57 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times with isopropyl alcohol, and the mixture was stirred for 2 hours to prepare a sample solution 1-5.

1.0 ml of the sample solution 1-5, 22.732 ml of isopropyl alcohol, 6.0 ml of water, and 0.268 ml of a solution as the curing inhibitor (C), in which DMS-S12 (manufactured by Gelest, Inc.; compound with n20 being 4 to 7 in (I-II-3) shown in Table 6 above) was diluted by 100 times in terms of mass ratio with isopropyl alcohol, were mixed to prepare a coating solution 1-5.

A film was formed on a glass substrate in the same manner as in Example 1-1 except that the coating solution 1-5 was used.

### Example 1-6

2.16×10⁻³ moles of n-decyltrimethoxysilane as the organosilicon compound (A) and 2.16×10⁻³ moles of tetraethyl orthosilicate as the organosilicon compound (B) were dissolved in 2.57 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times with isopropyl alcohol, and the mixture was stirred for 2 hours to prepare a sample solution 1-6.

1.0 ml of the sample solution 1-6, 22.732 ml of isopropyl alcohol, 6.0 ml of water, and 0.268 ml of a solution as the curing inhibitor (C), in which KR-410 (manufactured by Shin-Etsu Chemical Co., Ltd.; compound with n20 being 10 in (I-II-14) shown in Table 6 above) was diluted by 100 times in terms of mass ratio with isopropyl alcohol, were mixed to prepare a coating solution 1-6.

A film was formed on a glass substrate in the same manner as in Example 1-1 except that the coating solution 1-6 was used.

### Example 1-7

2.22×10⁻³ moles of n-decyltrimethoxysilane as the organosilicon compound (A) and 2.22×10⁻³ moles of tetraethyl orthosilicate as the organosilicon compound (B) were dissolved in 2.50 ml of isopropyl alcohol, and the solution was stirred at room temperature for 10 minutes. To the obtained solution was added dropwise 1.10 ml of 0.01 M hydrochloric acid, and the mixture was stirred at room temperature for 1 hour. To the obtained solution was added dropwise 0.267 ml of a solution of malonic acid diluted by 10 times in terms of mass ratio with isopropyl alcohol, and the mixture was stirred for 2 hours to prepare a sample solution 1-14.

1.0 ml of the sample solution 1-14, 10.733 ml of isopropyl alcohol, 3.0 ml of water, and 0.267 ml of a solution as the curing inhibitor (C), in which the compound 1 was diluted by 100 times in terms of mass ratio with isopropyl alcohol, were mixed to prepare a coating solution 1-14.

A film was formed on a glass substrate in the same manner as in Example 1-1 except that the coating solution 1-14 was used.

### Example 1-8

1.83×10⁻³ moles of n-decyltrimethoxysilane as the organosilicon compound (A) and 1.83×10⁻³ moles of tetraethyl orthosilicate as the organosilicon compound (B) were dissolved in 2.06 ml of isopropyl alcohol, and the solution was stirred at room temperature for 10 minutes. To the obtained solution was added dropwise 0.90 ml of 0.01 M hydrochloric acid, and the mixture was stirred at room temperature for 1 hour. To the obtained solution was added dropwise 1.102 ml of a solution of malonic acid diluted by 10 times in terms of mass ratio with isopropyl alcohol, and the mixture was stirred for 2 hours to prepare a sample solution 1-15.

0.1 ml of the sample solution 1-15, 22.873 ml of isopropyl alcohol, 27 ml of water, and 0.027 ml of a solution as the curing inhibitor (C), in which the compound 1 was diluted by 100 times in terms of mass ratio with isopropyl alcohol, were mixed to prepare a coating solution 1-15.

A film was formed on a glass substrate in the same manner as in Example 1-1 except that the coating solution 1-15 was used.

### Example 1-9

2.17×10⁻³ moles of hexyltriethoxysilane as the organosilicon compound (A) and 2.17×10⁻³ moles of tetraethyl orthosilicate as the organosilicon compound (B) were dissolved in 2.56 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.254 ml of a solution of malonic acid diluted by 10 times in terms of mass ratio with isopropyl alcohol, and the mixture was stirred for 2 hours to prepare a sample solution 1-16.

1.0 ml of the sample solution 1-16, 22.733 ml of isopropyl alcohol, 6.0 ml of water, and 0.267 ml of a solution as the curing inhibitor (C), in which the compound 1 was diluted by 100 times in terms of mass ratio with isopropyl alcohol, were mixed to prepare a coating solution 1-16.

A film was formed on a glass substrate in the same manner as in Example 1-1 except that the coating solution 1-16 was used.

### Example 1-10

1.58×10⁻³ moles of octadecyltriethoxysilane as the organosilicon compound (A) and 1.58×10⁻³ moles of tetraethyl orthosilicate as the organosilicon compound (B) were dissolved in 2.86 ml of isopropyl alcohol, and the solution was stirred at room temperature for 10 minutes. To the obtained solution was added dropwise 0.78 ml of 0.01 M hydrochloric acid, and the mixture was stirred at room temperature for 1 hour. To the obtained solution was added dropwise 0.253 ml of a solution of malonic acid diluted by 10 times in terms of mass ratio with isopropyl alcohol, and the mixture was stirred for hours to prepare a sample solution 1-17.

1.0 ml of the sample solution 1-17, 22.733 ml of isopropyl alcohol, 6.0 ml of water, and 0.267 ml of a solution as the curing inhibitor (C), in which the compound 1 was diluted by 100 times in terms of mass ratio with isopropyl alcohol, were mixed to prepare a coating solution 1-17.

A film was formed on a glass substrate in the same manner as in Example 1-1 except that the coating solution 1-17 was used.

### Example 1-11

3.53×10⁻³ moles of n-decyltrimethoxysilane as the organosilicon compound (A) and 3.53×10⁻⁴ moles of tetraethyl orthosilicate as the organosilicon compound (B) were dissolved in 2.79 ml of isopropyl alcohol, and the solution was stirred at room temperature for 10 minutes. To the obtained solution was added dropwise 0.85 ml of 0.01 M hydrochloric acid, and the mixture was stirred at room temperature for 1 hour. To the obtained solution was added dropwise 0.256 ml of a solution of malonic acid diluted by 10 times in terms of mass ratio with isopropyl alcohol, and the mixture was stirred for 2 hours to prepare a sample solution 1-18.

1.0 ml of the sample solution 1-18, 22.733 ml of isopropyl alcohol, 6.0 ml of water, and 0.267 ml of a solution as the curing inhibitor (C), in which the compound 1 was diluted by 100 times in terms of mass ratio with isopropyl alcohol, were mixed to prepare a coating solution 1-18.

A film was formed on a glass substrate in the same manner as in Example 1-1 except that the coating solution 1-18 was used.

### Example 1-12

1.01×10⁻⁴ moles of n-decyltrimethoxysilane as the organosilicon compound (A) and 4.87×10⁻³ moles of tetraethyl orthosilicate as the organosilicon compound (B) were dissolved in 2.79 ml of isopropyl alcohol, and the solution was stirred at room temperature for 10 minutes. To the obtained solution was added dropwise 0.85 ml of 0.01 M hydrochloric acid, and the mixture was stirred at room temperature for 1 hour. To the obtained solution was added dropwise 0.256 ml of a solution of malonic acid diluted by 10 times in terms of mass ratio with isopropyl alcohol, and the mixture was stirred for 2 hours to prepare a sample solution 1-19.

1.0 ml of the sample solution 1-19, 22.733 ml of isopropyl alcohol, 6.0 ml of water, and 0.267 ml of a solution as the curing inhibitor (C), in which the compound 1 was diluted by 100 times in terms of mass ratio with isopropyl alcohol, were mixed to prepare a coating solution 1-19.

A film was formed on a glass substrate in the same manner as in Example 1-1 except that the coating solution 1-19 was used.

### Example 1-13

2.16×10⁻³ moles of n-decyltrimethoxysilane as the organosilicon compound (A) and 2.16×10⁻³ moles of tetraethyl orthosilicate as the organosilicon compound (B) were dissolved in 2.30 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.521 ml of a solution of succinic acid diluted by 5 times in terms of mass ratio with isopropyl alcohol, and the mixture was stirred for 2 hours to prepare a sample solution 1-20.

1.0 ml of the sample solution 1-20, 22.733 ml of isopropyl alcohol, 6.0 ml of water, and 0.267 ml of a solution as the curing inhibitor (C), in which the compound 1 was diluted by 100 times in terms of mass ratio with isopropyl alcohol, were mixed to prepare a coating solution 1-20.

A film was formed on a glass substrate in the same manner as in Example 1-1 except that the coating solution 1-20 was used.

### Example 1-14

2.16×10⁻³ moles of n-decyltrimethoxysilane as the organosilicon compound (A) and 2.16×10⁻³ moles of tetraethyl orthosilicate as the organosilicon compound (B) were dissolved in 2.56 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.261 ml of a solution of tricarballylic acid diluted by 10 times in terms of mass ratio with isopropyl alcohol, and the mixture was stirred for 2 hours to prepare a sample solution 1-21.

1.0 ml of the sample solution 1-21, 22.733 ml of isopropyl alcohol, 6.0 ml of water, and 0.267 ml of a solution as the curing inhibitor (C), in which the compound 1 was diluted by 100 times in terms of mass ratio with isopropyl alcohol, were mixed to prepare a coating solution 1-21.

A film was formed on a glass substrate in the same manner as in Example 1-1 except that the coating solution 1-21 was used.

### Comparative Example 1-1

2.16×10⁻³ moles of n-decyltrimethoxysilane as the organosilicon compound (A) and 2.16×10⁻³ moles of tetraethyl orthosilicate as the organosilicon compound (B) were dissolved in 2.57 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-7.

1.0 ml of the sample solution 1-7, 23.0 ml of isopropyl alcohol and 6.0 ml of water were mixed to prepare a coating solution 1-7.

A film was formed on a glass substrate in the same manner as in Example 1-1 except that the coating solution 1-7 was used.

### Comparative Example 1-2

5.00×10⁻³ moles of tetraethyl orthosilicate as the organosilicon compound (B) was dissolved in 2.21 ml of isopropyl alcohol, and the solution was stirred at room temperature for 10 minutes. To the obtained solution was added dropwise 1.41 ml of 0.01 M hydrochloric acid, and the mixture was stirred at room temperature for 1 hour. To the obtained solution was added dropwise 0.27 ml of a solution of malonic acid diluted by 10 times in terms of mass ratio with isopropyl alcohol, and the mixture was stirred for 2 hours to prepare a sample solution 1-8.

1.0 ml of the sample solution 1-8, 28.732 ml of isopropyl alcohol, and 0.268 ml of a solution as the curing inhibitor (C), in which the compound 1 was diluted by 100 times in terms of mass ratio with isopropyl alcohol, were mixed to prepare a coating solution 1-8. A film was formed on a glass substrate in the same manner as in Example 1-1 except that the coating solution 1-8 was used.

### Comparative Example 1-3

5.00×10⁻³ moles of tetraethyl orthosilicate as the organosilicon compound (B) was dissolved in 2.21 ml of isopropyl alcohol, and the solution was stirred at room temperature for 10 minutes. To the obtained solution was added dropwise 1.41 ml of 0.01 M hydrochloric acid, and the mixture was stirred at room temperature for 1 hour. To the obtained solution was added dropwise 0.27 ml of a solution of malonic acid diluted by 10 times in terms of mass ratio with isopropyl alcohol, and the mixture was stirred for 2 hours to prepare a sample solution 1-9.

1.0 ml of the sample solution 1-9, 25.436 ml of isopropyl alcohol and 3.564 ml of the compound 1 as the curing inhibitor (C) were mixed to prepare a coating solution 1-9.

A film was formed on a glass substrate in the same manner as in Example 1-1 except that the coating solution 1-9 was used.

### Comparative Example 1-4

3.81×10⁻³ moles of n-decyltrimethoxysilane as the organosilicon compound (A) was dissolved in 2.83 ml of isopropyl alcohol, and the solution was stirred at room temperature for 10 minutes. To the obtained solution was added dropwise 0.81 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-10.

1.0 ml of the sample solution 1-10, 28.732 ml of isopropyl alcohol, and 0.268 ml of a solution as the curing inhibitor (C), in which X-24-9011 (manufactured by Shin-Etsu Chemical Co., Ltd.) was diluted by 100 times in terms of mass ratio with isopropyl alcohol, were mixed to prepare a coating solution 1-10.

A film was formed on a glass substrate in the same manner as in Example 1-1 except that the coating solution 1-10 was used.

### Comparative Example 1-5

3.81×10⁻³ moles of n-decyltrimethoxysilane as the organosilicon compound (A) was dissolved in 2.83 ml of isopropyl alcohol, and the solution was stirred at room temperature for 10 minutes. To the obtained solution was added dropwise 0.81 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-11.

1.0 ml of the sample solution 1-11, 28.920 ml of isopropyl alcohol and 0.080 ml of X-24-9011 (manufactured by Shin-Etsu Chemical Co., Ltd.) as the curing inhibitor (C) were mixed to prepare a coating solution 1-11.

A film was formed on a glass substrate in the same manner as in Example 1-1 except that the coating solution 1-11 was used.

### Comparative Example 1-6

3.81×10⁻³ moles of n-decyltrimethoxysilane as the organosilicon compound (A) was dissolved in 2.83 ml of isopropyl alcohol, and the solution was stirred at room temperature for 10 minutes. To the obtained solution was added dropwise 0.81 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-12.

1.0 ml of the sample solution 1-12, 28.732 ml of isopropyl alcohol, and 0.268 ml of a solution as the curing inhibitor (C), in which DMS-S12 (manufactured by Gelest, Inc.) was diluted by 100 times in terms of mass ratio with isopropyl alcohol, were mixed to prepare a coating solution 1-12.

A film was formed on a glass substrate in the same manner as in Example 1-1 except that the coating solution 1-12 was used.

### Comparative Example 1-7

3.81×10⁻³ moles of n-decyltrimethoxysilane as the organosilicon compound (A) was dissolved in 2.83 ml of isopropyl alcohol, and the solution was stirred at room temperature for 10 minutes. To the obtained solution was added dropwise 0.81 ml of 0.01 M hydrochloric acid, and the mixture was stirred at room temperature for 1 hour. To the obtained solution was added dropwise 0.26 ml of a solution of malonic acid diluted by 10 times in terms of mass ratio with isopropyl alcohol, and the mixture was stirred for 2 hours to prepare a sample solution 1-13.

1.0 ml of the sample solution 1-13, 28.920 ml of isopropyl alcohol and 0.080 ml of DMS-S12 (manufactured by Gelest, Inc.) as the curing inhibitor (C) were mixed to prepare a coating solution 1-13.

A film was formed on a glass substrate in the same manner as in Example 1-1 except that the coating solution 1-13 was used.

### Comparative Example 1-8

2.22×10⁻³ moles of n-decyltrimethoxysilane as the organosilicon compound (A) and 2.22×10⁻³ moles of tetraethyl orthosilicate as the organosilicon compound (B) were dissolved in 2.50 ml of isopropyl alcohol, and the solution was stirred at room temperature for 10 minutes. To the obtained solution was added dropwise 1.10 ml of 0.01 M hydrochloric acid, and the mixture was stirred at room temperature for 1 hour. To the obtained solution was added dropwise 0.267 ml of a solution of malonic acid diluted by 10 times in terms of mass ratio with isopropyl alcohol, and the mixture was stirred for 2 hours to prepare a sample solution 1-22.

1.0 ml of the sample solution 1-22, 11.0 ml of isopropyl alcohol and 3.0 ml of water were mixed to prepare a coating solution 1-22.

A film was formed on a glass substrate in the same manner as in Example 1-1 except that the coating solution 1-22 was used.

### Comparative Example 1-9

1.83×10⁻³ moles of n-decyltrimethoxysilane as the organosilicon compound (A) and 1.83×10⁻³ moles of tetraethyl orthosilicate as the organosilicon compound (B) were dissolved in 2.06 ml of isopropyl alcohol, and the solution was stirred at room temperature for 10 minutes. To the obtained solution was added dropwise 0.90 ml of 0.01 M hydrochloric acid, and the mixture was stirred at room temperature for 1 hour. To the obtained solution was added dropwise 1.102 ml of a solution of malonic acid diluted by 10 times in terms of mass ratio with isopropyl alcohol, and the mixture was stirred for 2 hours to prepare a sample solution 1-23.

0.1 ml of the sample solution 1-23, 22.9 ml of isopropyl alcohol and 27 ml of water were mixed to prepare a coating solution 1-23.

A film was formed on a glass substrate in the same manner as in Example 1-1 except that the coating solution 1-23 was used.

### Comparative Example 1-10

2.17×10⁻³ moles of hexyltriethoxysilane as the organosilicon compound (A) and 2.17×10⁻³ moles of tetraethyl orthosilicate as the organosilicon compound (B) were dissolved in 2.56 ml of isopropyl alcohol, and the solution was stirred at room temperature for 10 minutes. To the obtained solution was added dropwise 1.07 ml of 0.01 M hydrochloric acid, and the mixture was stirred at room temperature for 1 hour. To the obtained solution was added dropwise 0.254 ml of a solution of malonic acid diluted by 10 times in terms of mass ratio with isopropyl alcohol, and the mixture was stirred for 2 hours to prepare a sample solution 1-24.

1.0 ml of the sample solution 1-24, 23.0 ml of isopropyl alcohol and 6.0 ml of water were mixed to prepare a coating solution 1-24.

A film was formed on a glass substrate in the same manner as in Example 1-1 except that the coating solution 1-24 was used.

### Comparative Example 1-11

1.58×10⁻³ moles of octadecyltriethoxysilane as the organosilicon compound (A) and 1.58×10⁻³ moles of tetraethyl orthosilicate as the organosilicon compound (B) were dissolved in 2.86 ml of isopropyl alcohol, and the solution was stirred at room temperature for 10 minutes. To the obtained solution was added dropwise 0.78 ml of 0.01 M hydrochloric acid, and the mixture was stirred at room temperature for 1 hour. To the obtained solution was added dropwise 0.253 ml of a solution of malonic acid diluted by 10 times in terms of mass ratio with isopropyl alcohol, and the mixture was stirred for 2 hours to prepare a sample solution 1-25.

1.0 ml of the sample solution 1-25, 23.0 ml of isopropyl alcohol and 6.0 ml of water were mixed to prepare a coating solution 1-25.

A film was formed on a glass substrate in the same manner as in Example 1-1 except that the coating solution 1-25 was used.

### Comparative Example 1-12

3.53×10⁻³ moles of n-decyltrimethoxysilane as the organosilicon compound (A) and 3.53×10⁻⁴ moles of tetraethyl orthosilicate as the organosilicon compound (B) were dissolved in 2.79 ml of isopropyl alcohol, and the solution was stirred at room temperature for 10 minutes. To the obtained solution was added dropwise 0.85 ml of 0.01 M hydrochloric acid, and the mixture was stirred at room temperature for 1 hour. To the obtained solution was added dropwise 0.256 ml of a solution of malonic acid diluted by 10 times in terms of mass ratio with isopropyl alcohol, and the mixture was stirred for 2 hours to prepare a sample solution 1-26.

1.0 ml of the sample solution 1-26, 23.0 ml of isopropyl alcohol and 6.0 ml of water were mixed to prepare a coating solution 1-26.

A film was formed on a glass substrate in the same manner as in Example 1-1 except that the coating solution 1-26 was used.

### Comparative Example 1-13

1.01×10⁻⁴ moles of n-decyltrimethoxysilane as the organosilicon compound (A) and 4.87×10⁻³ moles of tetraethyl orthosilicate as the organosilicon compound (B) were dissolved in 2.23 ml of isopropyl alcohol, and the solution was stirred at room temperature for 10 minutes. To the obtained solution was added dropwise 1.40 ml of 0.01 M hydrochloric acid, and the mixture was stirred at room temperature for 1 hour. To the obtained solution was added dropwise 0.267 ml of a solution of malonic acid diluted by 10 times in terms of mass ratio with isopropyl alcohol, and the mixture was stirred for 2 hours to prepare a sample solution 1-27.

1.0 ml of the sample solution 1-27, 23.0 ml of isopropyl alcohol and 6.0 ml of water were mixed to prepare a coating solution 1-27.

A film was formed on a glass substrate in the same manner as in Example 1-1 except that the coating solution 1-27 was used.

### Example 2-1

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 2-1.

0.1 ml of the sample solution 2-1, 27.973 ml of isopropyl alcohol, 21.9 ml of water, and 0.027 ml of a solution as the curing inhibitor (C), in which KBM-603 (manufactured by Shin-Etsu Chemical Co., Ltd., N-2-(aminoethyl)-3-aminopropyltrimethoxysilane) was diluted by 10 times in terms of mass ratio with isopropyl alcohol, were mixed to prepare a coating solution 2-1.

A film was formed on a glass substrate in the same manner as in Example 1-1 except that the coating solution 2-1 was used.

### Example 2-2

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 2-2.

0.1 ml of the sample solution 2-2, 27.946 ml of isopropyl alcohol, 21.9 ml of water, and 0.054 ml of a solution as the curing inhibitor (C), in which KBM-603 (manufactured by Shin-Etsu Chemical Co., Ltd., N-2-(aminoethyl)-3-aminopropyltrimethoxysilane) was diluted by 10 times in terms of mass ratio with isopropyl alcohol, were mixed to prepare a coating solution 2-2.

A film was formed on a glass substrate in the same manner as in Example 1-1 except that the coating solution 2-2 was used.

### Example 2-3

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 2-3.

0.1 ml of the sample solution 2-3, 27.973 ml of isopropyl alcohol, 21.9 ml of water, and 0.027 ml of a solution as the curing inhibitor (C), in which KBM-6803 (manufactured by Shin-Etsu Chemical Co., Ltd., N-2-(aminoethyl)-8-aminooctyltrimethoxysilane) was diluted by 10 times in terms of mass ratio with isopropyl alcohol, were mixed to prepare a coating solution 2-3.

A film was formed on a glass substrate in the same manner as in Example 1-1 except that the coating solution 2-3 was used.

### Example 2-4

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 2-4.

0.1 ml of the sample solution 2-4, 27.946 ml of isopropyl alcohol, 21.9 ml of water, and 0.054 ml of a solution as the curing inhibitor (C), in which KBM-6803 (manufactured by Shin-Etsu Chemical Co., Ltd., N-2-(aminoethyl)-8-aminooctyltrimethoxysilane) was diluted by 10 times in terms of mass ratio with isopropyl alcohol, were mixed to prepare a coating solution 2-4.

A film was formed on a glass substrate in the same manner as in Example 1-1 except that the coating solution 2-4 was used.

### Example 2-5

9.41×10⁻⁴ moles of n-decyltrimethoxysilane as the organosilicon compound (A) and 3.76×10⁻³ moles of tetraethyl orthosilicate as the organosilicon compound (B) were dissolved in 1.31 ml of isopropyl alcohol, and the solution was stirred at room temperature for 10 minutes. To the obtained solution was added dropwise 1.26 ml of 0.01 M hydrochloric acid, and the mixture was stirred at room temperature for 1 hour. To the obtained solution was added dropwise 1.320 ml of a solution of malonic acid diluted by 10 times in terms of mass ratio with isopropyl alcohol, and the mixture was stirred for 2 hours to prepare a sample solution 2-6.

0.1 ml of the sample solution 2-6, 47.388 ml of isopropyl alcohol, 2.5 ml of water, and 0.012 ml of KBM-603 (manufactured by Shin-Etsu Chemical Co., Ltd., N-2-(aminoethyl)-3-aminopropyltrimethoxysilane) as the curing inhibitor (C) were mixed to prepare a coating solution 2-6.

A film was formed on a glass substrate in the same manner as in Example 1-1 except that the coating solution 2-6 was used.

### Comparative Example 2-1

9.42×10⁻⁴ moles of n-decyltrimethoxysilane as the organosilicon compound (A) and 3.78×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 2-5.

0.1 ml of the sample solution 2-5, 28.0 ml of isopropyl alcohol and 21.9 ml of water were mixed to prepare a coating solution 2-5.

A film was formed on a glass substrate in the same manner as in Example 1-1 except that the coating solution 2-5 was used.

### Comparative Example 2-2

3.80×10⁻³ moles of n-decyltrimethoxysilane as the organosilicon compound (A) was dissolved in 1.81 ml of isopropyl alcohol, and the solution was stirred at room temperature for 10 minutes. To the obtained solution was added dropwise 0.81 ml of 0.01 M hydrochloric acid, and the mixture was stirred at room temperature for 1 hour. To the obtained solution was added dropwise 1.278 ml of a solution of malonic acid diluted by 10 times in terms of mass ratio with isopropyl alcohol, and the mixture was stirred for 2 hours to prepare a sample solution 2-7.

0.1 ml of the sample solution 2-7, 27.973 ml of isopropyl alcohol, 21.9 ml of water, and 0.027 ml of a solution as the curing inhibitor (C), in which KBM-603 (manufactured by Shin-Etsu Chemical Co., Ltd., N-2-(aminoethyl)-3-aminopropyltrimethoxysilane) was diluted by 100 times in terms of mass ratio with isopropyl alcohol, were mixed to prepare a coating solution 2-7.

A film was formed on a glass substrate in the same manner as in Example 1-1 except that the coating solution 2-7 was used.

### Comparative Example 2-3

5.00×10⁻³ moles of tetraethyl orthosilicate as the organosilicon compound (B) was dissolved in 1.15 ml of isopropyl alcohol, and the solution was stirred at room temperature for 10 minutes. To the obtained solution was added dropwise 1.41 ml of 0.01 M hydrochloric acid, and the mixture was stirred at room temperature for 1 hour. To the obtained solution was added dropwise 1.334 ml of a solution of malonic acid diluted by 10 times in terms of mass ratio with isopropyl alcohol, and the mixture was stirred for 2 hours to prepare a sample solution 2-8.

0.1 ml of the sample solution 2-8, 27.973 ml of isopropyl alcohol, 21.9 ml of water, and 0.027 ml of a solution as the curing inhibitor (C), in which KBM-603 (manufactured by Shin-Etsu Chemical Co., Ltd., N-2-(aminoethyl)-3-aminopropyltrimethoxysilane) was diluted by 100 times in terms of mass ratio with isopropyl alcohol, were mixed to prepare a coating solution 2-8.

A film was formed on a glass substrate in the same manner as in Example 1-1 except that the coating solution 2-8 was used.

### Example 3-1

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 3-1.

0.1 ml of the sample solution 3-1, 27.946 ml of isopropyl alcohol, 21.9 ml of water, and 0.054 ml of a solution as the curing inhibitor (C), in which 1,2-bis(trimethoxysilyl)ethane was diluted by 10 times in terms of mass ratio with isopropyl alcohol, were mixed to prepare a coating solution 3-1.

A film was formed on a glass substrate in the same manner as in Example 1-1 except that the coating solution 3-1 was used.

### Example 3-2

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 3-2.

0.1 ml of the sample solution 3-2, 27.973 ml of isopropyl alcohol, 21.9 ml of water, and 0.027 ml of a solution as the curing inhibitor (C), in which 1,6-bis(trimethoxysilyl)hexane was diluted by 10 times in terms of mass ratio with isopropyl alcohol, were mixed to prepare a coating solution 3-2.

A film was formed on a glass substrate in the same manner as in Example 1-1 except that the coating solution 3-2 was used.

### Example 3-3

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 3-3.

0.1 ml of the sample solution 3-3, 27.946 ml of isopropyl alcohol, 21.9 ml of water, and 0.054 ml of a solution as the curing inhibitor (C), in which 1,6-bis(trimethoxysilyl)hexane was diluted by 10 times in terms of mass ratio with isopropyl alcohol, were mixed to prepare a coating solution 3-3.

A film was formed on a glass substrate in the same manner as in Example 1-1 except that the coating solution 3-3 was used.

### Example 3-4

9.42×10⁻⁴ moles of n-decyltrimethoxysilane as the organosilicon compound (A) and 3.77×10⁻³ moles of tetraethyl orthosilicate as the organosilicon compound (B) were dissolved in 1.30 ml of isopropyl alcohol, and the solution was stirred at room temperature for 10 minutes. To the obtained solution was added dropwise 1.27 ml of 0.01 M hydrochloric acid, and the mixture was stirred at room temperature for 1 hour. To the obtained solution was added dropwise 1.32 ml of a solution of malonic acid diluted by 10 times in terms of mass ratio with isopropyl alcohol, and the mixture was stirred for 2 hours to prepare a sample solution 3-4.

0.1 ml of the sample solution 3-4, 27.893 ml of isopropyl alcohol, 21.9 ml of water, and 0.107 ml of a solution as the curing inhibitor (C), in which 1,6-bis(trimethoxysilyl)hexane was diluted by 10 times in terms of mass ratio with isopropyl alcohol, were mixed to prepare a coating solution 3-4.

A film was formed on a glass substrate in the same manner as in Example 1-1 except that the coating solution 3-4 was used.

### Example 3-5

9.41×10⁻⁴ moles of n-decyltrimethoxysilane as the organosilicon compound (A) and 3.76×10⁻³ moles of tetraethyl orthosilicate as the organosilicon compound (B) were dissolved in 1.31 ml of isopropyl alcohol, and the solution was stirred at room temperature for 10 minutes. To the obtained solution was added dropwise 1.26 ml of 0.01 M hydrochloric acid, and the mixture was stirred at room temperature for 1 hour. To the obtained solution was added dropwise 1.320 ml of a solution of malonic acid diluted by 10 times in terms of mass ratio with isopropyl alcohol, and the mixture was stirred for 2 hours to prepare a sample solution 3-5.

0.1 ml of the sample solution 3-5, 47.382 ml of isopropyl alcohol, 2.5 ml of water, and 0.018 ml of 1,6-bis(trimethoxysilyl)hexane as the curing inhibitor (C) were mixed to prepare a coating solution 3-5.

A film was formed on a glass substrate in the same manner as in Example 1-1 except that the coating solution 3-5 was used.

### Comparative Example 3-1

3.80×10⁻³ moles of n-decyltrimethoxysilane as the organosilicon compound (A) was dissolved in 1.81 ml of isopropyl alcohol, and the solution was stirred at room temperature for 10 minutes. To the obtained solution was added dropwise 0.80 ml of 0.01 M hydrochloric acid, and the mixture was stirred at room temperature for 1 hour. To the obtained solution was added dropwise 1.278 ml of a solution of malonic acid diluted by 10 times in terms of mass ratio with isopropyl alcohol, and the mixture was stirred for 2 hours to prepare a sample solution 3-6.

0.1 ml of the sample solution 3-6, 27.973 ml of isopropyl alcohol, 21.9 ml of water, and 0.027 ml of a solution as the curing inhibitor (C), in which 1,6-bis(trimethoxysilyl)hexane was diluted by 100 times in terms of mass ratio with isopropyl alcohol, were mixed to prepare a coating solution 3-6.

A film was formed on a glass substrate in the same manner as in Example 1-1 except that the coating solution 3-6 was used.

### Comparative Example 3-2

5.00×10⁻³ moles of tetraethyl orthosilicate as the organosilicon compound (B) was dissolved in 1.15 ml of isopropyl alcohol, and the solution was stirred at room temperature for 10 minutes. To the obtained solution was added dropwise 1.41 ml of 0.01 M hydrochloric acid, and the mixture was stirred at room temperature for 1 hour. To the obtained solution was added dropwise 1.334 ml of a solution of malonic acid diluted by 10 times in terms of mass ratio with isopropyl alcohol, and the mixture was stirred for 2 hours to prepare a sample solution 3-7.

0.1 ml of the sample solution 3-7, 27.973 ml of isopropyl alcohol, 21.9 ml of water, and 0.027 ml of a solution as the curing inhibitor (C), in which 1,6-bis(trimethoxysilyl)hexane was diluted by 100 times in terms of mass ratio with isopropyl alcohol, were mixed to prepare a coating solution 3-7.

A film was formed on a glass substrate in the same manner as in Example 1-1 except that the coating solution 3-7 was used.

TABLE 7-1

| | | | | Example | Example | Example | Example | Example |
|---|---|---|---|---|---|---|---|---|
| | | | | 1-1 | 1-2 | 1-3 | 1-4 | 1-5 |
| Compound | Organosilicon | | Hexyltriethoxysilane | | | | | |
| (mass %) | compound | | n-Decyltrimethoxysilane | 0.46 | 0.46 | 0.46 | 0.46 | 0.46 |
| | (A) | | Octadecyltriethoxysilane | | | | | |
| | Organosilicon | | Tetraethyl | 0.36 | 0.36 | 0.36 | 0.36 | 0.36 |
| | compound | | orthosilicate | | | | | |
| | (B) | | | | | | | |
| | Curing | C1 | Compound 1 | 0.00095 | 0.00095 | 0.047 | — | — |
| | inhibitor | | X-24-9011 | — | — | — | 0.00095 | — |
| | (C) | | DMS-S12 | — | — | — | — | 0.00095 |
| | | | KR-410 | — | — | — | — | — |
| | | C2 | KBM603 | — | — | — | — | — |
| | | | KBM6803 | — | — | — | — | — |
| | | C3 | [symbol] | — | — | — | — | — |
| | | | [symbol] | — | — | — | — | — |
| | Water (D) (excludng | | | 24.2 | 24.2 | 24.2 | 24.2 | 24.2 |
| | water from catalyst) | | | | | | | |
| | Solvent (E) | | Isopropyl alcohol | 74.1 | 74.1 | 74.1 | 74.1 | 74.1 |
| | Catalyst (F) | | Hydrogen chloride | 0.00031 | 0.00031 | 0.00031 | 0.00031 | 0.00031 |
| | | | [symbol] | 0.86 | 0.86 | 0.86 | 0.86 | 0.86 |
| | Carboxylic | | Malonic acid | 0.016 | 0.016 | 0.016 | 0.016 | 0.016 |
| | acid | | Succinic acid | — | — | — | — | — |
| | compound | | Tricarballylic acid | — | — | — | — | — |
| | (G) | | | | | | | |
| Solid content (mass %) | | | A + B | 022 | 0.82 | 0.82 | 0.82 | 0.82 |
| | | | A + B + C | 022 | 0.82 | 0.83 | 0.87 | 0.83 |
| Molar ratio | | | B/A | 1 | 1 | 1 | 1 | 1 |
| | | | C/(A + B) | 0.00012 | 0.00012 | 0.00012 | 0.00012 | 0.00012 |
| Mass ratio | | | C/(A + B) | 0.0012 | 0.0012 | 0.0012 | 0.0012 | 0.0012 |
| | | | D/(A + B) | 29.5 | 29.5 | 29.5 | 29.5 | 29.5 |
| | | | E/(A + B) | 90.5 | 90.5 | 90.5 | 90.5 | 90.5 |
| | | | F/(A + B) | 0.00038 | 0.00038 | 0.00038 | 0.00038 | 0.00038 |
| | | | C/D | 0.00039 | 0.00039 | 0.00039 | 0.00039 | 0.00039 |
| | | | C/E | 0.000013 | 0.000013 | 0.000013 | 0.000013 | 0.000013 |
| | | | C/F | 3.0 | 30.3 | 152 | 30.3 | 30.3 |
| | | | | Example | Example | Example | Example | Example |
| | | | | 1-6 | 1-7 | 1-8 | 1-9 | 1-10 |
| Compound | Organosilicon | | Hexyltriethoxysilane | | — | — | 0.45 | — |
| (mass %) | compound | | n-Decyltrimethoxysilane | 0.46 | 0.94 | 0.021 | — | — |
| | (A) | | Octadecyltriethoxysilane | | — | — | — | 0.55 |
| | Organosilicon | | Tetraethyl | 0.36 | 0.74 | 0.017 | 0.36 | 0.27 |
| | compound | | orthosilicate | | | | | |
| | (B) | | | | | | | |
| | Curing | C1 | Compound 1 | — | 0.017 | 0.00046 | 0.0084 | 0.0084 |
| | inhibitor | | X-24-9011 | — | — | — | — | — |
| | (C) | | DMS-S12 | — | — | — | — | — |
| | | | KR-410 | 0.00095 | — | — | — | — |
| | | C2 | KBM603 | — | — | — | — | — |
| | | | KBM6803 | — | — | — | — | — |
| | | C3 | [symbol] | — | — | — | — | — |
| | | | [symbol] | — | — | — | — | — |
| | Water (D) (excludng | | | 24.2 | 24.1 | 60.0 | 24.2 | 24.2 |
| | water from catalyst) | | | | | | | |
| | Solvent (E) | | Isopropyl alcohol | 74.1 | 72.4 | 39.9 | 74.1 | 74.3 |
| | Catalyst (F) | | Hydrogen chloride | 0.00031 | 0.00064 | 0.000015 | 0.00032 | 0.00023 |
| | | | [symbol] | 0.86 | 1.76 | 0.040 | 0.86 | 0.63 |
| | Carboxylic | | Malonic acid | 0.016 | 0.035 | 0.0040 | 0.017 | 0.017 |
| | acid | | Succinic acid | — | — | — | — | — |
| | compound | | Tricarballylic acid | — | — | — | — | — |
| | (G) | | | | | | | |
| Solid content (mass %) | | | A + B | 0.82 | 1.68 | 0.04 | 0.82 | 0.82 |
| | | | A + B + C | 0.83 | 1.70 | 0.04 | 0.83 | 0.82 |
| Molar ratio | | | B/A | 1 | 1 | 1 | 1 | 1 |
| | | | C/(A + B) | 0.0039 | 0.0011 | 0.0013 | 0.0011 | 0.0015 |
| Mass ratio | | | C/(A + B) | 0.012 | 0.010 | 0.012 | 0.010 | 0.010 |
| | | | D/(A + B) | 29.5 | 14.4 | 1568.3 | 29.5 | 29.6 |
| | | | E/(A + B) | 90.5 | 43.1 | 1041.7 | 90.5 | 91.1 |
| | | | F/(A + B) | 0.00038 | 0.00039 | 0.00038 | 0.00028 | 0.00028 |
| | | | C/D | 0.00039 | 0.00070 | 0.000008 | 0.00035 | 0.00035 |
| | | | C/E | 0.00013 | 0.00023 | 0.000012 | 0.00011 | 0.00011 |
| | | | C/F | 30.3 | 25.2 | 31.8 | 26.7 | 36.8 |

| | | | |
|---|---|---|---|
| Example | Example | Example | Example |
| 1-11 | 1-12 | 1-13 | 1-14 |

| Compound | Organosilicon | Hexyltriethoxysilane | — | — | — | — |
|---|---|---|---|---|---|---|
| (mass %) | compound | n-Decyltrimethoxysilane | 0.75 | 0.021 | 0.46 | 0.46 |
| | (A) | Octadecyltriethoxysilane | — | — | — | — |
| | Organosilicon | Tetraethyl | 0.089 | 0.82 | 0.36 | 0.36 |
| | compound | orthosilicate | | | | |
| | (B) | | | | | |

| | | | | | | |
|---|---|---|---|---|---|---|
| Curing | C1 | Compound 1 | 0.0084 | 0.0084 | 0.0084 | 0.0084 |
| inhibitor | | X-24-9011 | — | — | — | — |
| (C) | | DMS-S12 | — | — | — | — |
| | | KR-410 | — | — | — | — |
| | C2 | KBM603 | — | — | — | — |
| | | KBM6803 | — | — | — | — |
| | C3 | [symbol] | — | — | — | — |
| | | [symbol] | — | — | — | — |

| Water (D) (excludng | | 24.2 | 24.2 | 24.2 | 24.2 |
|---|---|---|---|---|---|
| water from catalyst) | | | | | |
| Solvent (E) | Isopropyl alcohol | 74.3 | 73.9 | 74.1 | 74.1 |
| Catalyst (F) | Hydrogen chloride | 0.00025 | 0.00041 | 0.00031 | 0.00031 |
| | [symbol] | 0.68 | 1.12 | 0.86 | 0.86 |
| Carboxylic | Malonic acid | 0.017 | 0.018 | — | — |
| acid | Succinic acid | — | — | 0.017 | — |
| compound | Tricarballylic acid | — | — | — | 0.017 |
| (G) | | | | | |

| Solid content (mass %) | A + B | 0.81 | 0.84 | 0.82 | 0.82 |
|---|---|---|---|---|---|
| | A + B + C | 0.82 | 0.85 | 0.83 | 0.83 |
| Molar ratio | B/A | 0.1 | 48 | 1 | 1 |
| | C/(A + B) | 0.0012 | 0.0010 | 0.0011 | 0.0011 |
| Mass ratio | C/(A + B) | 0.010 | 0.010 | 0.010 | 0.010 |
| | D/(A + B) | 30.0 | 28.8 | 29.5 | 29.5 |
| | E/(A + B) | 92.1 | 88.1 | 90.4 | 90.4 |
| | F/(A + B) | 0.00031 | 0.00049 | 0.00038 | 0.00038 |
| | C/D | 0.00035 | 0.00035 | 0.00035 | 0.00035 |
| | C/E | 0.00011 | 0.00011 | 0.00011 | 0.00011 |
| | C/F | 33.8 | 20.5 | 26.9 | 26.9 |

[symbol]

indicates data missing or illegible when filed

TABLE 7-2

| | | | | Comparative | Comparative | Comparative | Comparative | Comparative |
|---|---|---|---|---|---|---|---|---|
| | | | | Example | Example | Example | Example | Example |
| | | | | 1-1 | 1-2 | 1-3 | 1-4 | 1-5 |
| Compound | Organosilicon | | Hexyltriethoxysilane | — | — | — | — | — |
| (mass %) | compound | | n-Decyltrimethoxysilane | 0.46 | — | — | 0.85 | 0.85 |
| | (A) | | Octadecyltriethoxysilane | — | — | — | — | — |
| | Organosilicon | | Tetraethyl | 0.36 | 0.88 | 0.87 | — | — |
| | compound | | orthosilicate | | | | | |
| | (B) | | | | | | | |
| | Curing | C1 | Compound 1 | — | 0.010 | 13.13 | — | — |
| | inhibitor | | X-24-9011 | — | — | — | 0.010 | 13.13 |
| | (C) | | DMS-S12 | — | — | — | — | — |
| | | | KR-410 | — | — | — | — | — |
| | | C2 | KBM603 | — | — | — | — | — |
| | | | KBM6803 | — | — | — | — | — |
| | | C3 | [symbol] | — | — | — | — | — |
| | | | [symbol] | — | — | — | — | — |
| | Water (D) (excludng | | | 24.2 | 0 | 0 | 0 | 0 |
| | water from catalyst) | | | | | | | |
| | Solvent (E) | | Isopropyl alcohol | 74.1 | 97.9 | 84.8 | 98.4 | 98.1 |
| | Catalyst (F) | | Hydrogen chloride | 0.00031 | 0.00044 | 0.00043 | 0.00025 | 0.00025 |
| | | | [symbol] | 0.86 | 1.20 | 1.18 | 0.69 | 0.69 |
| | Carboxylic | | Malonic acid | 0.016 | 0.018 | 0.017 | 0.017 | 0.017 |
| | acid | | Succinic acid | — | — | — | — | — |
| | compound | | Tricarballylic acid | — | — | — | — | — |
| | (G) | | | | | | | |
| Solid content (mass %) | | | A + B | 0.82 | 0.87 | 0.85 | 0.85 | 0.85 |
| | | | A + B + C | 0.82 | 0.89 | 14.00 | 0.86 | 1.15 |
| Molar ratio | | | B/A | 1 | — | — | — | — |
| | | | C/(A + B) | 0 | 0.0011 | 1.4 | 0.00091 | 0.027 |
| Mass ratio | | | C/(A + B) | 0 | 0.011 | 15.1 | 0.012 | 0.35 |
| | | | D/(A + B) | 29.5 | 0 | 0 | 0 | 0 |
| | | | E/(A + B) | 90.5 | 111 | 97.3 | 116 | 115 |
| | | | F/(A + B) | 0.00038 | 0.00049 | 0.00049 | 0.00029 | 0.00029 |
| | | | C/D | 0 | — | — | — | — |
| | | | C/E | 0 | 0.00010 | 0.15 | 0.00010 | 0.0031 |
| | | | C/F | 0 | 22.9 | 30457 | 40.1 | 1203 |
| | | | | Comparative | Comparative | Comparative | Comparative | Comparative |
| | | | | Example | Example | Example | Example | Example |
| | | | | 1-6 | 1-7 | 1-8 | 1-9 | 1-10 |
| Compound | Organosilicon | | Hexyltriethoxysilane | — | — | — | — | 0.45 |
| (mass %) | compound | | n-Decyltrimethoxysilane | 0.85 | 0.85 | 0.94 | 0.021 | — |
| | (A) | | Octadecyltriethoxysilane | — | — | — | — | — |
| | Organosilicon | | Tetraethyl | — | — | 0.74 | 0.017 | 0.36 |
| | compound | | orthosilicate | | | | | |
| | (B) | | | | | | | |
| | Curing | C1 | Compound 1 | — | — | — | — | — |
| | inhibitor | | X-24-9011 | — | — | — | — | — |
| | (C) | | DMS-S12 | 0.010 | 0.30 | — | — | — |
| | | | KR-410 | — | — | — | — | — |
| | | C2 | KBM603 | — | — | — | — | — |
| | | | KBM6803 | — | — | — | — | — |
| | | C3 | [symbol] | — | — | — | — | — |
| | | | [symbol] | — | — | — | — | — |
| | Water (D) (excludng | | | 0 | 0 | 24.1 | 60.0 | 24.2 |
| | water from catalyst) | | | | | | | |
| | Solvent (E) | | Isopropyl alcohol | 98.4 | 98.1 | 72.4 | 39.9 | 74.1 |
| | Catalyst (F) | | Hydrogen chloride | 0.00025 | 0.00025 | 0.00064 | 0.000015 | 0.00032 |
| | | | [symbol] | 0.89 | 0.89 | 1.78 | 0.040 | 0.86 |
| | Carboxylic | | Malonic acid | 0.017 | 0.017 | 0.035 | 0.0040 | 0.017 |
| | acid | | Succinic acid | — | — | — | — | — |
| | compound | | Tricarballylic acid | — | — | — | — | — |
| | (G) | | | | | | | |
| Solid content (mass %) | | | A + B | 0.85 | 0.85 | 1.68 | 0.04 | 0.82 |
| | | | A + B + C | 0.86 | 1.15 | 1.68 | 0.04 | 0.82 |
| Molar ratio | | | B/A | — | — | 1 | 1 | 1 |
| | | | C/(A + B) | 0.0057 | 0.17 | 0 | 0 | 0 |
| Mass ratio | | | C/(A + B) | 0.012 | 0.35 | 0 | 0 | 0 |
| | | | D/(A + B) | 0 | 0 | 14.4 | 1568 | 29.5 |
| | | | E/(A + B) | 116 | 115 | 43.2 | 1042 | 90.5 |
| | | | F/(A + B) | 0.00029 | 0.00029 | 0.00038 | 0.00038 | 0.00038 |
| | | | C/D | — | — | 0 | 0 | 0 |
| | | | C/E | 0.00010 | 0.0031 | 0 | 0 | 0 |
| | | | C/F | 40.1 | 1203 | 0 | 0 | 0 |

| | | | | Comparative | Comparative | Comparative |
|---|---|---|---|---|---|---|
| | | | | Example | Example | Example |
| | | | | 1-11 | 1-12 | 1-13 |
| Compound | Organosilicon | | Hexyltriethoxysilane | — | — | — |
| (mass %) | compound | | n-Decyltrimethoxysilane | — | 0.75 | 0.021 |
| | (A) | | Octadecyltriethoxysilane | 0.55 | — | — |
| | Organosilicon | | Tetraethyl | 0.27 | 0.059 | 0.82 |
| | compound | | orthosilicate | — | — | — |
| | (B) | | | | | |
| | Curing | C1 | Compound 1 | — | — | — |
| | inhibitor | | X-24-9011 | — | — | — |
| | (C) | | DMS-S12 | — | — | — |
| | | | KR-410 | — | — | — |
| | | C2 | KBM603 | — | — | — |
| | | | KBM6803 | — | — | — |
| | | C3 | [symbol] | — | — | — |
| | | | [symbol] | — | — | — |
| | Water (D) (excludng | | | 24.2 | 24.2 | 24.2 |
| | water from catalyst) | | | | | |
| | Solvent (E) | | Isopropyl alcohol | 74.4 | 74.3 | 73.9 |
| | Catalyst (F) | | Hydrogen chloride | 0.00023 | 0.00025 | 0.00041 |
| | | | [symbol] | 0.63 | 0.68 | 1.12 |
| | Carboxylic | | Malonic acid | 0.017 | 0.017 | 0.018 |
| | acid | | Succinic acid | — | — | — |
| | compound | | Tricarballylic acid | — | — | — |
| | (G) | | | | | |
| Solid content (mass %) | | | A + B | 0.82 | 0.81 | 0.84 |
| | | | A + B + C | 0.82 | 0.81 | 0.84 |
| Molar ratio | | | B/A | 1 | 0.1 | 48 |
| | | | C/(A + B) | 0 | 0 | 0 |
| Mass ratio | | | C/(A + B) | 0 | 0 | 0 |
| | | | D/(A + B) | 29.6 | 30.0 | 28.8 |
| | | | E/(A + B) | 91.1 | 92.1 | 88.2 |
| | | | F/(A + B) | 0.00028 | 0.00031 | 0.00049 |
| | | | C/D | 0 | 0 | 0 |
| | | | C/E | 0 | 0 | 0 |
| | | | C/F | 0 | 0 | 0 |

[symbol]

indicates data missing or illegible when filed

TABLE 8

| | | | | Example | Example | Example | Example |
|---|---|---|---|---|---|---|---|
| | | | | 2-1 | 2-2 | 2-3 | 2-4 |
| Compound | Organosilicon | | Hexyltriethoxysilane | — | — | — | — |
| (mass %) | compound | | n-Decyltrimethoxysilane | 0.011 | 0.011 | 0.011 | 0.011 |
| | (A) | | Octadecyltriethoxysilane | — | — | — | — |
| | Organosilicon | | Tetraethyl | 0.036 | 0.036 | 0.036 | 0.036 |
| | compound | | orthosilicate | | | | |
| | (B) | | | | | | |
| | Curing | C1 | Compound 1 | — | — | — | — |
| | inhibitor | | X-24-9011 | — | — | — | — |
| | (C) | | DMS-S12 | — | — | — | — |
| | | | KR-410 | — | — | — | — |
| | | C2 | KBM603 | 0.0063 | 0.0128 | — | — |
| | | | KBM6803 | — | — | 0.0063 | 0.0125 |
| | | C3 | [symbol] | — | — | — | — |
| | | | [symbol] | — | — | — | — |
| | Water (D) (excludng | | | 49.9 | 49.9 | 49.9 | 49.9 |
| | water from catalyst) | | | | | | |
| | Solvent (E) | | Isopropyl alcohol | 50.0 | 49.9 | 50.0 | 49.9 |
| | Catalyst (F) | | Hydrogen chloride | 0.000021 | 0.000021 | 0.000021 | 0.000021 |
| | | | [symbol] | 0.058 | 0.058 | 0.058 | 0.058 |
| | Carboxylic | | Malonic acid | 0.0047 | 0.0047 | 0.0047 | 0.0047 |
| | acid | | Succinic acid | — | — | — | — |
| | compound | | Tricarballylic acid | — | — | — | — |
| | (G) | | | | | | |
| Solid content (mass %) | | | A + B | 0.047 | 0.047 | 0.047 | 0.047 |
| | | | A + B + C | 0.053 | 0.060 | 0.053 | 0.060 |
| Molar ratio | | | B/A | 4 | 4 | 4 | 4 |
| | | | C/(A + B) | 0.13 | 0.26 | 0.10 | 0.20 |
| Mass ratio | | | C/(A + B) | 0.13 | 0.27 | 0.13 | 0.27 |
| | | | D/(A + B) | 1061 | 1061 | 1061 | 1061 |
| | | | E/(A + B) | 1061 | 1061 | 1061 | 1061 |
| | | | F/(A + B) | 0.0004 | 0.0004 | 0.0004 | 0.0004 |
| | | | C/D | 0.000125 | 0.00025 | 0.000126 | 0.00025 |
| | | | C/E | 0.000125 | 0.00025 | 0.000126 | 0.00025 |
| | | | C/F | 298.3 | 596.5 | 298.3 | 596.6 |
| | | | | | Comparative | Comparative | Comparative |
| | | | | Example | Example | Example | Example |
| | | | | 2-5 | 2-1 | 2-2 | 2-3 |
| Compound | Organosilicon | | Hexyltriethoxysilane | — | — | — | — |
| (mass %) | compound | | n-Decyltrimethoxysilane | 0.012 | 0.011 | 0.046 | — |
| | (A) | | Octadecyltriethoxysilane | — | — | — | — |
| | Organosilicon | | Tetraethyl | 0.040 | 0.036 | — | 0.48 |
| | compound | | orthosilicate | | | | |
| | (B) | | | | | | |
| | Curing | C1 | Compound 1 | — | — | — | — |
| | inhibitor | | X-24-9011 | — | — | — | — |
| | (C) | | DMS-S12 | — | — | — | — |
| | | | KR-410 | — | — | — | — |
| | | C2 | KBM603 | 0.032 | — | 0.00049 | 0.00046 |
| | | | KBM6803 | — | — | — | — |
| | | C3 | [symbol] | — | — | — | — |
| | | | [symbol] | — | — | — | — |
| | Water (D) (excludng | | | 6.3 | 49.9 | 49.9 | 49.9 |
| | water from catalyst) | | | | | | |
| | Solvent (E) | | Isopropyl alcohol | 93.5 | 50.0 | 50.0 | 49.9 |
| | Catalyst (F) | | Hydrogen chloride | 0.000023 | 0.000021 | 0.000013 | 0.000023 |
| | | | [symbol] | 0.064 | 0.058 | 0.037 | 0.064 |
| | Carboxylic | | Malonic acid | 0.0055 | 0.0047 | 0.0048 | 0.0050 |
| | acid | | Succinic acid | — | — | — | — |
| | compound | | Tricarballylic acid | — | — | — | — |
| | (G) | | | | | | |
| Solid content (mass %) | | | A + B | 0.052 | 0.047 | 0.046 | 0.048 |
| | | | A + B + C | 0.064 | 0.047 | 0.046 | 0.048 |
| Molar ratio | | | B/A | 4 | 4 | 0 | — |
| | | | C/(A + B) | 0.60 | 0 | 0.01 | 0.01 |
| Mass ratio | | | C/(A + B) | 0.61 | 0 | 0.01 | 0.01 |
| | | | D/(A + B) | 121 | 1061 | 1097 | 1051 |
| | | | E/(A + B) | 1797 | 1062 | 1097 | 1051 |
| | | | F/(A + B) | 0.0004 | 0.0004 | 0.0003 | 0.0005 |
| | | | C/D | 0.01 | 0 | 0.00001 | 0.00001 |
| | | | C/E | 0.00034 | 0 | 0.00001 | 0.00001 |
| | | | C/F | 1363.0 | 0 | 35.6 | 20.3 |

[symbol]

indicates data missing or illegible when filed

TABLE 9

| | | | | Example | Example | Example | Example |
|---|---|---|---|---|---|---|---|
| | | | | 3-1 | 3-2 | 3-3 | 3-4 |
| Compound | Organosilicon | | Hexyltriethoxysilane | — | — | — | — |
| (mass %) | compound | | n-Decyltrimethoxysilane | 0.011 | 0.011 | 0.011 | 0.011 |
| | (A) | | Octadecyltriethoxysilane | — | — | — | — |
| | Organosilicon | | Tetraethyl | 0.036 | 0.036 | 0.036 | 0.036 |
| | compound | | orthosilicate | | | | |
| | (B) | | | | | | |
| | Curing | C1 | Compound 1 | — | — | — | — |
| | inhibitor | | X-24-9011 | — | — | — | — |
| | (C) | | DMS-S12 | — | — | — | — |
| | | | KR-410 | — | — | — | — |
| | | C2 | KBM603 | — | — | — | — |
| | | | KBM6803 | — | — | — | — |
| | | C3 | [symbol] | — | — | — | — |
| | | | [symbol] | 0.0130 | — | — | — |
| | Water (D) (excludng | | | 49.9 | 49.9 | 49.9 | 49.9 |
| | water from catalyst) | | | | | | |
| | Solvent (E) | | Isopropyl alcohol | 49.9 | 50.0 | 49.9 | 49.9 |
| | Catalyst (F) | | Hydrogen chloride | 0.000021 | 0.000021 | 0.000021 | 0.000021 |
| | | | [symbol] | 0.058 | 0.058 | 0.058 | 0.058 |
| | Carboxylic | | Malonic acid | 0.0047 | 0.0047 | 0.0047 | 0.0047 |
| | acid | | Succinic acid | — | — | — | — |
| | compound | | Tricarballylic acid | — | — | — | — |
| | (G) | | | | | | |
| Solid content (mass %) | | | A + B | 0.047 | 0.047 | 0.047 | 0.047 |
| | | | A + B + C | 0.060 | 0.053 | 0.060 | 0.072 |
| Molar ratio | | | B/A | 4 | 4 | 4 | 4 |
| | | | C/(A + B) | 0.22 | 0.089 | 0.18 | 0.36 |
| Mass ratio | | | C/(A + B) | 0.28 | 0.13 | 0.27 | 0.53 |
| | | | D/(A + B) | 1061 | 1061 | 1061 | 1061 |
| | | | E/(A + B) | 1061 | 1061 | 1061 | 1061 |
| | | | F/(A + B) | 0.0004 | 0.0004 | 0.0004 | 0.0004 |
| | | | C/D | 0.00026 | 0.000125 | 0.00025 | 0.00050 |
| | | | C/E | 0.00026 | 0.000125 | 0.00025 | 0.00050 |
| | | | C/F | 619.8 | 296.5 | 593.1 | 1186.2 |

| | | | | | Comparative | Comparative |
|---|---|---|---|---|---|---|
| | | | | Example | Example | Example |
| | | | | 3-5 | 3-1 | 3-2 |
| Compound | Organosilicon | | Hexyltriethoxysilane | — | — | — |
| (mass %) | compound | | n-Decyltrimethoxysilane | 0.012 | 0.046 | — |
| | (A) | | Octadecyltriethoxysilane | — | — | — |
| | Organosilicon | | Tetraethyl | 0.040 | — | 0.048 |
| | compound | | orthosilicate | | | |
| | (B) | | | | | |
| | Curing | C1 | Compound 1 | — | — | — |
| | inhibitor | | X-24-9011 | — | — | — |
| | (C) | | DMS-S12 | — | — | — |
| | | | KR-410 | — | — | — |
| | | C2 | KBM603 | — | — | — |
| | | | KBM6803 | — | — | — |
| | | C3 | [symbol] | — | — | — |
| | | | [symbol] | — | — | — |
| | Water (D) (excludng | | | 6.3 | 49.9 | 49.9 |
| | water from catalyst) | | | | | |
| | Solvent (E) | | Isopropyl alcohol | 93.5 | 50.0 | 49.9 |
| | Catalyst (F) | | Hydrogen chloride | 0.000023 | 0.000013 | 0.000023 |
| | | | [symbol] | 0.064 | 0.037 | 0.064 |
| | Carboxylic | | Malonic acid | 0.0055 | 0.0048 | 0.0050 |
| | acid | | Succinic acid | — | — | — |
| | compound | | Tricarballylic acid | — | — | — |
| | (G) | | | | | |
| Solid content (mass %) | | | A + B | 0.052 | 0.046 | 0.048 |
| | | | A + B + C | 0.100 | 0.046 | 0.048 |
| Molar ratio | | | B/A | 4 | 0 | — |
| | | | C/(A + B) | 0.61 | 0.01 | 0.01 |
| Mass ratio | | | C/(A + B) | 0.91 | 0.01 | 0.01 |
| | | | D/(A + B) | 121 | 1097 | 1051 |
| | | | E/(A + B) | 1797 | 1098 | 1051 |
| | | | F/(A + B) | 0.0004 | 0.0003 | 0.0005 |
| | | | C/D | 0.01 | 0.00001 | 0.00001 |
| | | | C/E | 0.00051 | 0.00001 | 0.00001 |
| | | | C/F | 2044.5 | 35.6 | 20.3 |

[symbol]

indicates data missing or illegible when filed

The film on the glass substrate which had been obtained in each of Examples and Comparative Examples above was evaluated by the following method.

### [Measurement of Contact Angle]

Using a contact angle measuring apparatus (DM 700 manufactured by Kyowa Interface Science Co., Ltd.), the contact angle of water on a surface of the film was measured at a liquid volume of 3 μL by a θ/2 method.

### [Measurement of Outdoor Durability]

The outdoor durability of the film obtained in each of Examples and Comparative Examples above was evaluated by a durability test involving actual outdoor exposure, or a combined durability test simulating the foregoing durability test.

### (1) Outdoor Exposure Test

The film obtained in each of Examples 2-1, 2-2, 2-3, 2-4, 3-1, 3-2, 3-3 and 3-4 and Comparative Example 2-1 was exposed outdoors for a month, followed by measuring the contact angle as described above.

### (2) Combined Durability Test

The film obtained in each of Examples 1-1 to 1-14, Comparative Examples 1-1 to 1-13, Example 2-5, Comparative Examples 2-2 and 2-3, Example 3-5 and Comparative Examples 3-1 and 3-2 was left to stand at 80° C. for 3 days using Forced Convection Oven DKN 402 (manufactured by Yamato Science co., ltd.), and then exposed to a water flow at a flow rate of 320 ml/min for a day. Thereafter, the contact angle was measured as described above.

### [Measurement of Slip Drop Speed]

The slip drop speed in each of Examples 1-1 to 1-14, Comparative Examples 1-2 to 1-4, 1-6 and 1-8 to 1-13, Examples 2-1 to 2-5, Comparative Examples 2-2 and 2-3, Examples 3-1 to 3-5 and Comparative Examples 3-1 and 3-2 was measured in the following manner.

Water was dropped to a surface of the film, and the water-repellent property was evaluated on the basis of the slip drop speed of the water droplet on the surface of the film. Specifically, with the contact angle measuring apparatus (DM 700 manufactured by Kyowa Interface Science Co., Ltd.), 35 μL of water was dropped to a surface of the film on a glass substrate inclined at 20°, the time until slip drop of the water droplet by 15 mm from the initial dropping position was measured, and the slip drop speed (mm/sec) of the water droplet on the surface of the film was calculated.

Tables 10 to 15 show the results of the measurements of contact angles, outdoor durability and slip drop speeds.

TABLE 10

Contact angle (°)

| No. | Initial stage | After test |
|---|---|---|
| Example 1-1 | 108.9 | 96.8 |
| Example 1-2 | 108.3 | 95.9 |
| Example 1-3 | 106.8 | 99.0 |
| Example 1-4 | 108.6 | 98.2 |
| Example 1-5 | 108.7 | 98.1 |
| Example 1-6 | 108.9 | 96.5 |
| Example 1-7 | 109.1 | 101.4 |
| Example 1-8 | 107.9 | 92.3 |
| Example 1-9 | 103.9 | 96.1 |
| Example 1-10 | 106.1 | 101.0 |
| Example 1-11 | 101.5 | 98.8 |
| Example 1-12 | 103.1 | 88.6 |
| Example 1-13 | 107.2 | 95.8 |
| Example 1-14 | 108.5 | 96.2 |
| Comparative | 107.7 | 84.5 |
| Example 1-1 | | |
| Comparative | 74.6 | 77.1 |
| Example 1-2 | | |
| Comparative | 104.9 | 103.1 |
| Example 1-3 | | |
| Comparative | 100.0 | 88.2 |
| Example 1-4 | | |
| Comparative | 96.3 | 87.2 |
| Example 1-5 | | |
| Comparative | 100.5 | 87.5 |
| Example 1-6 | | |
| Comparative | 98.7 | 80.1 |
| Example 1-7 | | |
| Comparative | 108.5 | 90.1 |
| Example 1-8 | | |
| Comparative | 107.4 | 74.3 |
| Example 1-9 | | |
| Comparative | 103.9 | 84.8 |
| Example 1-10 | | |
| Comparative | 105.7 | 88.7 |
| Example 1-11 | | |
| Comparative | 99.9 | 89.6 |
| Example 1-12 | | |
| Comparative | 101.2 | 78.8 |
| Example 1-13 | | |

TABLE 11

| | Slip drop |
|---|---|
| | speed |
| | (m/sec) |
| Example 1-1 | 108.3 |
| Example 1-2 | 98.6 |
| Example 1-3 | 92.8 |
| Example 1-4 | 85.6 |
| Example 1-5 | 82.8 |
| Example 1-6 | 84.8 |
| Example 1-7 | 81.4 |
| Example 1-8 | 90.8 |
| Example 1-9 | 56.5 |
| Example 1-10 | 35.0 |
| Example 1-11 | 69.3 |
| Example 1-12 | 32.8 |
| Example 1-13 | 102.3 |
| Example 1-14 | 104.5 |
| Comparative | 1.6 |
| Example 1-2 | |
| Comparative | 14.9 |
| Example 1-3 | |
| Comparative | 1.6 |
| Example 1-4 | |
| Comparative | 1.6 |
| Example 1-6 | |
| Comparative | 78.9 |
| Example 1-8 | |
| Comparative | 94.9 |
| Example 1-9 | |
| Comparative | 49.8 |
| Example 1-10 | |
| Comparative | 39.4 |
| Example 1-11 | |
| Comparative | 89.5 |
| Example 1-12 | |
| Comparative | 30.2 |
| Example 1-13 | |

The films obtained by applying a mixed composition in which the organosilicon compound (A), the organosilicon compound (B) and the compound (C1) as a curing inhibitor were used were excellent in water-repellent property and water slip drop property, maintained a high contact angle even after the durability test, and hence had excellent outdoor durability (Examples 1-1 to 1-14). On the other hand, Comparative Example 1-1 in which the curing inhibitor (C) was not used had a larger decrease in contact angle after the durability test, and hence poorer outdoor durability, as compared to Examples 1-1 to 1-6 in which the same types and amounts of the organosilicon compound (A) and the organosilicon compound (B) as in Comparative Example 1-1 were used. Comparison between Example and Comparative Example in which the same types and amounts of the organosilicon compound (A) and the organosilicon compound (B) were used, i.e. comparison between Example 1-7 and Comparative Example 1-8, comparison between Example 1-8 and Comparative Example 1-9, comparison between Example 1-9 and Comparative Example 1-10, comparison between Example 1-10 and Comparative Example 1-11 or comparison between Example 1-12 and Comparative Example 1-13 shows that when the curing inhibitor (C) was not used, the film had a large decrease in contact angle after the durability test, and hence poor outdoor durability.

Further, Comparative Examples 1-2 to 1-7 in which the curing inhibitor (C) was used and one of the organosilicon compound (A) and the organosilicon compound (B) was not used did not attain both a good water-repellent property and water slip drop property and good outdoor durability.

TABLE 12

Contact angle (°)

| No. | Initial stage | After test |
|---|---|---|
| Example 2-1 | 109.1 | 90.9 |
| Example 2-2 | 107.3 | 93.6 |
| Example 2-3 | 108.6 | 89.8 |
| Example 2-4 | 107.2 | 95.8 |
| Example 2-5 | 105.1 | 84.8 |
| Comparative | 109.9 | 70.5 |
| Example 2-1 | | |
| Comparative | 104.4 | 73.6 |
| Example 2-2 | | |
| Comparative | 39.4 | 49.0 |
| Example 2-3 | | |

TABLE 13

| | Slip drop |
|---|---|
| | speed |
| | (m/sec) |
| Example 2-1 | 92.3 |
| Example 2-2 | 89.5 |
| Example 2-3 | 95.5 |
| Example 2-4 | 90.3 |
| Example 2-5 | 32.2 |
| Comparative | 9.7 |
| Example 2-2 | |
| Comparative | 0 |
| Example 2-3 | |

The films obtained by applying a mixed composition in which the organosilicon compound (A), the organosilicon compound (B) and the compound (C2) as a curing inhibitor were used were excellent in water-repellent property and water slip drop property, maintained a high contact angle even after the durability test, and hence had excellent outdoor durability (Examples 2-1 to 2-5). On the other hand, Comparative Example 2-1 in which the curing inhibitor (C) was not used had a larger decrease in contact angle after the durability test. Comparative Examples 2-2 and 2-3 in which the curing inhibitor (C) was used and one of the organosilicon compound (A) and the organosilicon compound (B) was not used did not attain both a good water-repellent property and water slip drop property and good outdoor durability.

TABLE 14

Contact angle (°)

| No. | Initial stage | After test |
|---|---|---|
| Example 3-1 | 109.7 | 90.7 |
| Example 3-2 | 109.2 | 87.1 |
| Example 3-3 | 109.3 | 89.1 |
| Example 3-4 | 105.4 | 88.4 |
| Example 3-5 | 106.5 | 96.2 |
| Comparative | 102.1 | 82.7 |
| Example 3-1 | | |
| Comparative | 24.0 | 47.1 |
| Example 3-2 | | |

TABLE 15

| | Slip drop |
|---|---|
| | speed |
| | (m/sec) |
| Example 3-1 | 90.1 |
| Example 3-2 | 92.4 |
| Example 3-3 | 89.2 |
| Example 3-4 | 82.7 |
| Example 3-5 | 64.1 |
| Comparative | 7.8 |
| Example 3-1 | |
| Comparative | 0 |
| Example 3-2 | |

The films obtained by applying a mixed composition in which the organosilicon compound (A), the organosilicon compound (B) and the compound (C3) as a curing inhibitor were used were excellent in water-repellent property and water slip drop property, maintained a high contact angle even after the durability test, and hence had excellent outdoor durability (Examples 3-1 to 3-5). On the other hand, Comparative Examples 3-1 and 3-2 in which the curing inhibitor (C) was used and one of the organosilicon compound (A) and the organosilicon compound (B) was not used did not attain both a good water-repellent property and water slip drop property and good outdoor durability.

1. A mixed composition of an organosilicon compound (A) represented by formula (a1), an organosilicon compound (B) represented by formula (b1) and a curing inhibitor (C):
[Formula 1]
R^{a1}—Si(X^{a1})₃ (a1)
wherein R^{a1} represents a hydrocarbon group having 6 or more carbon atoms, and —CH₂— in the hydrocarbon group is optionally replaced by —O—; and
X^{a1} represents a hydrolyzable group, and
[Formula 2]
Si(R^{b1})_{b20}(X^{b1})_{4-b20} (b1)
wherein R^{b1} represents a hydrocarbon group having 1 to 5 carbon atoms;
X^{b1} represents a hydrolyzable group; and
b20 is 0 or 1.

2. A mixed composition of an organosilicon compound (A) represented by formula (a1), an organosilicon compound (B) represented by formula (b1), a curing inhibitor (C) and water (D):
[Formula 3]
R^{a1}—Si(X^{a1})₃ (a1)
wherein R^{a1} represents a hydrocarbon group having 6 or more carbon atoms, and —CH₂— in the hydrocarbon group is optionally replaced by —O—; and
X^{a1} represents a hydrolyzable group, and
[Formula 4]
Si(R^{b1})_{b20}(X^{b1})_{4-b20} (b1)
wherein R^{b1} represents a hydrocarbon group having 1 to 5 carbon atoms;
X^{b1} represents a hydrolyzable group; and
b20 is 0 or 1.

3. The composition according to claim 2, wherein the amount of water (D) is 0.1 to 90 mass %.

4. The composition according to claim 1, wherein the molar ratio (B/A) of the organosilicon compound (B) to the organosilicon compound (A) is 0.01 to 48.

5. The composition according to claim 1, wherein the total amount of the organosilicon compound (A) and the organosilicon compound (B) is 0.01 to 30 mass %.

6. The composition according to claim 1, wherein the mass ratio (C/(A+B)) of the curing inhibitor (C) to the total amount of the organosilicon compound (A) and the organosilicon compound (B) is 0.9 or less.

7. The composition according to claim 1, wherein R^{a1} in formula (a1) is a saturated hydrocarbon group.

8. The composition according to claim 1, wherein the curing inhibitor (C) comprises a compound (C1) having at least one selected from a hydroxy group and a hydrolyzable group at an end and containing a siloxane bond in a structure.

9. The composition according to claim 8, wherein the compound (C1) is a compound represented by formula (c1): 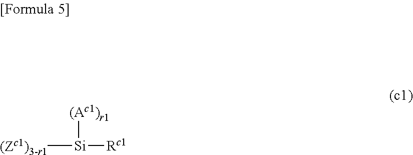
wherein A^{c1} represents a hydroxy group or a hydrolyzable group, and a plurality of Acts, when present, are optionally different from each other;
Z^{c1} represents a hydrocarbon group, a trialkylsilyl group-containing molecular chain or a siloxane backbone-containing group, and a plurality of Z^{c1}s, when present, are optionally different from each other;
r1 represents an integer of 1 to 3; and
R represents a group represented by formula (c11): 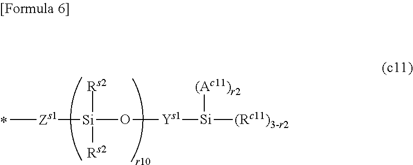
wherein R^{s2}s each independently represent an alkyl group having 1 to 4 carbon atoms;
R^{c11} represents a hydrocarbon group or a trialkylsilyloxy group, hydrogen atoms in the hydrocarbon group or the trialkylsilyloxy group are optionally replaced by fluorine atoms, and a plurality of R^{c11}s, when present, are optionally different from each other;
A^{c11} represents a hydroxy group or a hydrolyzable group, and a plurality of A^{c11}s, when present, are optionally different from each other;
Z^{s1} represents —O— or a divalent hydrocarbon group, and —CH₂— in the divalent hydrocarbon group is optionally replaced by —O—;
Y^{s1} represents a singly bond or —Si(R^{s2})₂-L^{s1}-, L^{s1} represents a divalent hydrocarbon group, and —CH₂— in the divalent hydrocarbon group is optionally replaced by —O—;
r2 represents an integer of 0 to 3;
r10 represents an integer of 1 or more; and
* represents a bond.

10. The composition according to claim 9, wherein the compound represented by formula (c1) is a compound represented by formula (c1-1): 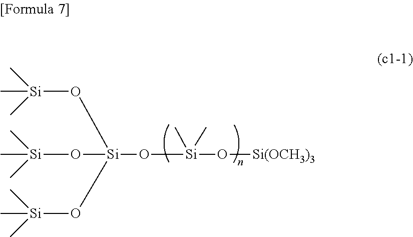
wherein n is an integer of 1 to 30.

11. The composition according to claim 1, wherein the curing inhibitor (C) comprises a compound represented by formula (c2): 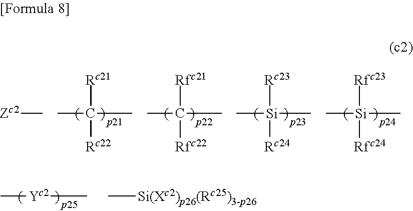
wherein R^{c21}, R^{c22}, R^{c23} and R^{c24} are each independently a hydrogen atom or an alkyl group having 1 to 4 carbon atoms, a plurality of R^{c21}s, when present, are optionally different from each other, a plurality of R^{c2}s, when present, are optionally different from each other, a plurality of R^{c23}s, when present, are optionally different from each other, and a plurality of R^{c24}s, when present, are optionally different from each other;
Rf^{c21}, Rf^{c22}, Rf^{c23}; and Rf^{c24} are each independently an alkyl group having 1 to 20 carbon atoms with one or more hydrogen atoms replaced by fluorine atoms, or a fluorine atom, a plurality of Rf^{c21}s, when present, are optionally different from each other, a plurality of Rf^{c22}s, when present, are optionally different from each other, a plurality of Rf^{c23}s, when present, are optionally different from each other, and a plurality of Rf^{s24}s, when present, are optionally different from each other;
R^{c25} is an alkyl group having 1 to 20 carbon atoms, and a plurality of R^{c25}s, when present, are optionally different from each other;
X^{c2} is a hydrolyzable group, and a plurality of X^{c2}s, when present, are optionally different from each other;
Y^{c2} is —O—, —NH— or —S—, and a plurality of Y^{c2}s, when present, are optionally different from each other;
Z^{c2} is a vinyl group, an α-methylvinyl group, a styryl group, a methacryloyl group, an acryloyl group, an amino group, an isocyanate group, an isocyanurate group, an epoxy group, an ureido group or a mercapto group;
p21 is an integer of 1 to 20, p22, p23 and p24 are each independently an integer of 0 to 10, and p25 is an integer of 0 to 10;
p26 is an integer of 1 to 3; and
Z^{c2}—, —Si(X^{c2})ₚ₂₆(R^{c25})₃₋ₚ₂₆, p21-{C(R^{c21})(R^{c22})}-s, p22-{C(Rf^{c21})(Rf^{c22})})-s, p23-{Si(R^{c23})(R^{c24})}-s, p24-{Si(Rf^{c23})(Rf^{c24})}-s and p25-Y^{c2}-s are bonded in line in any order as long as Z^{c2}— and —Si(X^{c2})ₚ₂₆(R^{c25})₃₋ₚ₂₆ are at the ends and —Y^{c2}-s are not connected to each other.

12. The composition according to claim 11, wherein the compound represented by formula (c2) is a compound represented by formula (c2-1):
[Formula 9]
Z^{c21}—C_{q}H_{2q}—Y^{c21}—CᵣH₂ᵣ—Si(X^{c21})ₚ₂₇(R^{c26})₃₋ₚ₂₇ (c2-1)
wherein X^{c21} is a methoxy group or an ethoxy group, and X^{c21}s, when present, are optionally different from each other;
Y^{c21} is —NH—, —CH₂— or —O—;
Z^{c21} is an amino group or a mercapto group;
R^{c26} is an alkyl group having 1 to 20 carbon atoms, and R^{c26}s, when present, are optionally different from each other;
p27 is an integer of 1 to 3;
q is an integer of 2 to 5; and
r is an integer of 0 to 10.

13. The composition according to claim 1, wherein the curing inhibitor (C) comprises a compound represented by formula (c3):
[Formula 10]
(X^{c3})₃Si—R^{c3}—Si(X^{c3})₃ (c3)
wherein a plurality of X^{c3}s each independently represent a hydrolyzable group; and
R^{c3} represents an alkylene group having 1 to 24 carbon atoms, —CH₂— in the alkylene group is optionally replaced by —O—, —NH— or —S—, and hydrogen atoms in the alkylene group are optionally replaced by fluorine atoms.

14. The composition according to claim 13, wherein the compound represented by formula (c3) is a compound represented by formula (c3-1):
[Formula 11]
(X^{c31})₃Si—(CH₂)ₙ₃₀—S(X^{c31})₃ (c3-1)
wherein a plurality of X^{c31}s each independently represent a methoxy group or an ethoxy group; and
n30 is an integer of 1 to 6.

15. A film obtained by curing the composition according to claim 1,

16. Vehicle glass at least one surface of which is provided with the film according to claim 15.
